(19) United States
(12) Patent Application Publication
(10) Pub. No.: US 2014/0104382 A1
(43) Pub. Date: Apr. 17, 2014

(54) IMAGE PROCESSING APPARATUS, MULTI-LENS IMAGE CAPTURE APPARATUS, IMAGE PROCESSING METHOD AND PROGRAM

(71) Applicant: FUJIFILM Corporation, Tokyo (JP)

(72) Inventor: Koji MORI, Saitama-shi (JP)

(73) Assignee: FUJIFILM Corporation, Tokyo (JP)

(21) Appl. No.: 14/096,694

(22) Filed: Dec. 4, 2013

Related U.S. Application Data
(63) Continuation of application No. PCT/JP2012/060863, filed on Apr. 23, 2012.

(30) Foreign Application Priority Data
Jun. 6, 2011 (JP) 2011-126295

(51) Int. Cl. H04N 13/00; H04N 13/04; H04N 13/02

(52) U.S. Cl. CPC H04N 13/0018; H04N 13/021; H04N 13/0425
USPC 348/43

(57) ABSTRACT

An image processing apparatus, a multi-lens image capture apparatus, an image processing method and program are provided that are capable of ascertaining an abnormal parallax amount both easily and at high precision. A parallax amount (a far side parallax amount graph and a near side parallax amount graph) and an index for determining whether or not the parallax amount is abnormal (indented side permissible limit line, projection side permissible limit line, and marker) are comparably displayed whilst a frame that is to be subject to processing is being displayed on a monitor.

### CROSS-REFERENCE TO RELATED APPLICATION

This application is a continuation application of International Application No. PCT/JP/2012/060863, filed Apr. 23, 2012, the disclosure of which is incorporated herein by reference in its entirety. Further, this application claims priority from Japanese Patent Application No. 2011-126295, filed Jun. 6, 2011, the disclosure of which is incorporated herein by reference in its entirety.

### BACKGROUND OF THE INVENTION

1. Field of the Invention

The present invention relates to an image processing apparatus, a multi-lens image capture apparatus and an image processing method and program.

2. Description of the Related Art

A multi-lens image capture apparatus has been proposed that is equipped with plural image capture sections, and generates a 3D viewing image. The multi-lens imaging apparatus generates the 3D viewing image based on plural viewpoint images respectively generated by the plurality of image capture sections and displays this 3D viewing image on a 3D viewing monitor.

The 3D sensation of the 3D viewing image captured by the multi-lens imaging apparatus varies according to the separation of the user's eyes and the distance from the 3D viewing monitor to the user, there is accordingly an issue that large individual differences arise regarding 3D viewing functions of the multi-lens imaging apparatus. Hence in a multi-lens imaging apparatus it is possible to adjust parallax of plural viewpoint images according to operation by a user, thereby adjusting the 3D sensation of the 3D viewing image.

There is also a proposal (Japanese Patent Application Laid-Open (JP-A) No. 2005-73012) for technology to perform parallax amount adjustment that matches to the intention of a user who initially performed parallax amount adjustment, irrespective of the type of display displaying the 3D viewing image. According to such technology, data relating to parallax amount adjustment is created based on parallax amount change requests, and this is converted into data in units that do not depend on the type of display. Then after reading the recording data, data relating to parallax amount adjustment is created based on this data, and then an image for use in 3D display is generated based on that data.

Moreover, there is a proposal in JP-A No. 2004-221700 for technology that identifies parallax to match the intention of a user whilst a 3D viewing image is being displayed. According to the technology according to JP-A No. 2004-221700, a limit parallax of the 3D viewing image displayed on a display device is identified according to instructions of a user, and the image processing is performed such that the appropriate parallax when the 3D viewing image was previously displayed is implemented.

However, with both the technology of JP-A No. 2005-73012 and JP-A No. 2004-221700, there is sometimes a problem at the initial stage, for example, there is sometimes a problem with the parallax amount itself derived from the plural viewpoint images obtained by the image capture section, and appropriate parallax amount adjustment cannot be performed using the technology of JP-A No. 2005-73012 and JP-A No. 2004-221700 in cases in which it ceases to be possible to detect the parallax adjustment subject. There is a proposal for technology that makes a user aware of the level of the parallax amount of an image being displayed on a screen in cases in which an image is displayed on a screen without appropriate parallax adjustment (see for example JP-A No. 2008-103820).

In JP-A No. 2008-103820 technology is proposed to enable the distribution of parallax during reproduction of video image data containing 3D image data to be determined at a glance. According to this technology, a user is made aware of the magnitude of the parallax by changing the color for each of constant regions of parallax magnitude, preventing adverse impact on the body while a user is viewing a video image including a 3D image before it occurs.

### SUMMARY

However, in the technology described in JP-A No. 2008-103820, there is still an issue that although it is possible for a user to determine at a glance the parallax amount, it is difficult to ascertain whether or not this parallax amount is abnormal.

In consideration of the above circumstances, an object of the present invention is to provide an image processing apparatus, a multi-lens image capture apparatus and an image processing method and program that are capable of ascertaining an abnormal parallax amount both easily and at high precision.

In order to achieve the above object, an image processing apparatus of a first aspect of the present invention is configured including: an image acquisition means that acquires successive frame images obtained by successively imaging the same subject from plural respective viewpoints; a parallax amount acquisition means that acquires parallax amounts for each of plural frame images based on each of the plural frame images configuring the successive frame images acquired using the image acquisition means; a display means that displays frame images configuring successive frame images acquired using the image acquisition means so as to be visualized as a 3D viewing image; a reception means that receives processing instruction data that instructs parallax amount processing on the frame image; a processing means that performs the parallax amount processing instructed by the processing instruction data received by the reception means on the frame image displayed on the display means; and a control means that during display on the display means of the frame image instructed for parallax amount processing by the processing means controls the display means so as to associate together and display parallax amount related data related to the parallax amount acquired by the parallax amount acquisition means with an index for determining whether or not the parallax amount is abnormal.

An image processing apparatus according to a second aspect of the present invention is the image processing apparatus of the first aspect, wherein the parallax amount acquisition means acquires a parallax amount based on a predetermined subject image as a subject image of a parallax amount acquisition subject in the frame image.

An image processing apparatus according to a third aspect of the present invention is the image processing apparatus of the second aspect, wherein a subject image with a spatial frequency of a specific value or greater in the frame image is used as the predetermined subject image.

An image processing apparatus according to a fourth aspect of the present invention is the image processing apparatus of any one of the first aspect to the third aspect, wherein the control means during display on the display means of the frame image instructed for parallax amount processing by the processing means further controls the display means so as to display the following associated with each other: data representing a permissible limit of parallax amount; data representing change with time in parallax amount; and data enabling parallax of a frame image currently being displayed to be ascertained in the data representing changes with time in the parallax amount.

An image processing apparatus according to a fifth aspect of the present invention is the image processing apparatus of the fourth aspect wherein the data representing the parallax amount permissible limit and the data representing the change with time in the parallax amount are each respectively associated with the far side and the near side of the subject image.

An image processing apparatus according to a sixth aspect of the present invention is the image processing apparatus of any one of the first aspect to the fifth aspect, further including an abnormal determination means that determines the parallax amount to be abnormal in at least one case out of the group consisting of a case in which change at fixed durations in the parallax amount acquired by the parallax amount acquisition means is greater than a specific value, a case in which the parallax amount reaches a predetermined permissible limit value, and a case in which the parallax amount acquisition subject cannot be detected; wherein, in cases in which the parallax amount has been determined to be abnormal by the abnormal determination means, the control means further controls the display means such that a warning is displayed at the same time as displaying the frame image corresponding to the parallax amount.

An image processing apparatus according to a seventh aspect of the present invention is the image processing apparatus of the sixth aspect, further including a parallax adjustment means that performs a first parallax adjustment in cases in which it is determined by the abnormal determination means that the parallax amount is not abnormal, and that switches control to and performs parallax adjustment by a second parallax adjustment different from control of the first parallax adjustment in cases in which it is determined by the abnormal determination means that the parallax amount is abnormal; wherein, in cases in which the frame image that is subject to processing by the processing means is displayed on the display means, the control means further controls the display means such that the frame image to which parallax adjustment has been performed by the parallax adjustment means is displayed.

An image processing apparatus according to an eighth aspect of the present invention is the image processing apparatus of the seventh aspect, wherein the parallax adjustment means performs parallax adjustment within a range of a predetermined parallax amount maximum amount in cases in which the parallax amount is determined to be abnormal by the abnormal determination means.

An image processing apparatus according to a ninth aspect of the present invention is the image processing apparatus of the seventh aspect or the eighth aspect, wherein the parallax adjustment means performs parallax adjustment using the parallax amount of the previous frame in cases in which the parallax amount is determined to be abnormal by the abnormal determination means.

An image processing apparatus according to a tenth aspect of the present invention is the image processing apparatus of any one of the seventh aspect to the ninth aspect, wherein the parallax adjustment means lowers the frequency of parallax adjustment when the parallax amount is determined to be abnormal by the abnormal determination means.

A multi-lens imaging apparatus according to an eleventh aspect of the present invention is configured including: the image processing apparatus of any one of the first aspect to the tenth aspect; and an image capture means that generates the successive frame images by capturing successive frames of the same subject from plural viewpoints.

An image processing method according to a twelfth aspect of the present invention is an image processing method including: acquiring successive frame images obtained by successively imaging the same subject from plural respective viewpoints; acquiring parallax amounts for each of plural frame images based on each of the plural frame images configuring the acquired successive frame images; displaying frame images configuring the acquired successive frame images so as to be visualized as a 3D viewing image; receiving processing instruction data that instructs parallax amount processing on the frame image; performing the parallax amount processing instructed by the received processing instruction data on the displayed frame image; and during display of the frame image instructed for parallax amount processing, associating together and displaying parallax amount related data related to the acquired parallax amount with an index for determining whether or not the parallax amount is abnormal.

A program according to a thirteenth aspect of the present invention causes a computer to function as: an image acquisition means that acquires successive frame images obtained by successively imaging the same subject from plural respective viewpoints; a parallax amount acquisition means that acquires parallax amounts for each of plural frame images based on each of the plural frame images configuring the successive frame images acquired using the image acquisition means; a means that displays on a display means frame images configuring successive frame images acquired using the image acquisition means so as to be visualized as a 3D viewing image; a reception means that receives processing instruction data that instructs parallax amount processing on the frame image; a processing means that performs the parallax amount processing instructed by the processing instruction data received by the reception means on the frame image displayed on the display means; and a control means that during display on the display means of the frame image instructed for parallax amount processing by the processing means controls the display means so as to associate together and display parallax amount related data related to the parallax amount acquired by the parallax amount acquisition means with an index for determining whether or not the parallax amount is abnormal.

The present invention exhibits the advantageous effect of enabling an abnormal parallax amount to be ascertained both simply and with high precision.

### BRIEF DESCRIPTION OF DRAWINGS

FIG. 1 is a perspective view schematically illustrating image reproduction processing equipment;

FIG. 2 is a block diagram illustrating a schematic configuration of a display apparatus side of image reproduction processing equipment;

FIG. 3 is a diagram displaying a file format of an image file for 3D viewing;

FIG. 4 is a block diagram illustrating a schematic configuration of a liquid crystal shutter multi-lens side of image reproduction processing equipment;

FIG. 5 is a flow chart illustrating a 3D video editing routine according to a first basic embodiment;

FIG. 6 is a flow chart illustrating a first parallax amount acquisition routine;

FIG. 7 is a flow chart illustrating a second parallax amount acquisition routine;

FIG. 8 is a schematic diagram illustrating a display example of a parallax amount display screen;

FIG. 9A a diagram illustrating an example of a state of a parallax amount display screen overlaid on a frame being displayed on a monitor, in an example with a normal parallax amount;

FIG. 9B a diagram illustrating an example of a state of a parallax amount display screen overlaid on a frame being displayed on a monitor, in an example with an abnormal parallax amount;

FIG. 10 is a flow chart illustrating a first hunting presence/absence determination routine;

FIG. 11 is a flow chart illustrating a second hunting presence/absence determination routine;

FIG. 12 is a flow chart illustrating a 3D image editing routine according to a first exemplary embodiment;

FIG. 13 is a configuration diagram illustrating a modified example of image reproduction processing equipment according to the first exemplary embodiment;

FIG. 14 is a flow chart illustrating a 3D image editing routine according to a second basic embodiment;

FIG. 15 is a flow chart illustrating a 3D image editing routine according to a second exemplary embodiment;

FIG. 16 is a continuation of the flow chart illustrated in FIG. 15;

FIG. 17 is a flow chart illustrating a 3D video editing routine according to a third basic embodiment;

FIG. 18 is a flow chart illustrating a 3D video editing routine according to a third exemplary embodiment;

FIG. 19 is a continuation of the flow chart illustrated in FIG. 18;

FIG. 20 is a flow chart illustrating a 3D video editing routine according to a fourth basic embodiment;

FIG. 21A is a diagram illustrating a state in which a parallax adjustment subject is marked with a GUI;

FIG. 21B is a diagram illustrating a state in which a parallax adjustment subject is marked with a GUI:

FIG. 21C is a diagram illustrating a state in which a parallax adjustment subject is marked with a GUI;

FIG. 22 is a flow chart illustrating a 3D video editing routine according to a fourth exemplary embodiment;

FIG. 23 is a continuation of the flow chart illustrated in FIG. 22;

FIG. 24 is a front side perspective view of a multi-lens camera;

FIG. 25 is a rear side perspective view of a multi-lens camera;

FIG. 26 is a schematic block diagram illustrating an internal configuration of a multi-lens camera;

FIG. 27 is a diagram illustrating a configuration of an image capture section;

FIG. 28 is a diagram illustrating a configuration of a monitor;

FIG. 29 is a diagram illustrating a configuration of a lenticular sheet;

FIG. 30 is a diagram to explain 3D processing on a left eye image and a right eye image;

FIG. 31 is diagram illustrating an example of parallax related data;

FIG. 32 A is diagram to explain parallax related data; and

FIG. 32 B is diagram to explain parallax related data.

### DETAILED DESCRIPTION

### First Basic Embodiment

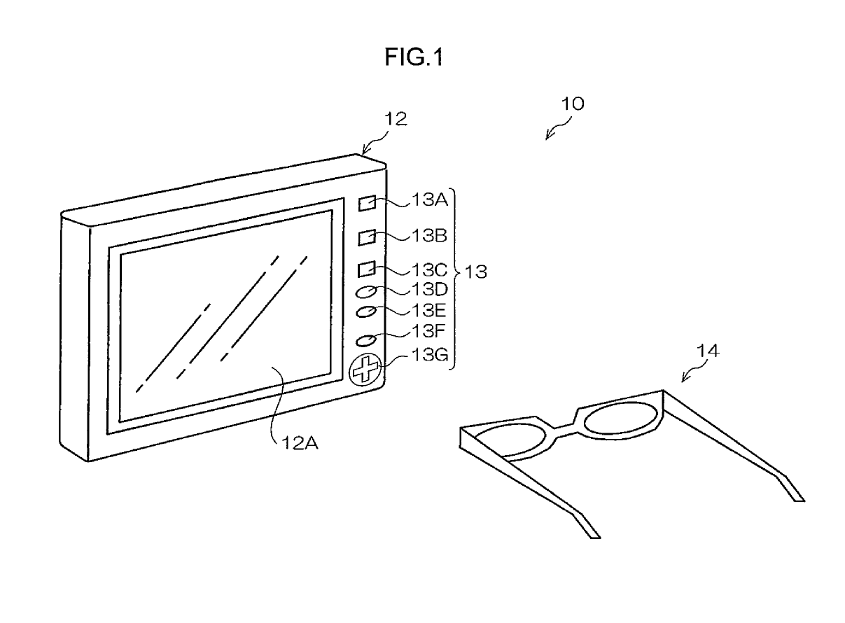

FIG. 1 is a diagram schematically illustrating image reproduction processing equipment 10 according to a first basic embodiment that is a premise to a first exemplary embodiment of the present invention, described later.

As illustrated in FIG. 1, the image reproduction processing equipment 10 is equipped with a display device 12 that displays a 3D viewing image, and liquid crystal shutter glasses 14. The display device 12 is equipped with a monitor 12A that performs various displays. The display device 12 is also equipped with an operation section 13 configured including: a power source button 13A that is press operated to switch on power; a reproduction start button 13B that is press operated to reproduce a 3D viewing image; a reproduction stop button 13C that is press operated to stop reproduction of a 3D viewing image; a menu button 13D that is press operated to display a menu screen containing data to be selected by a user on the monitor 12A; a cancel button 13E that is press operated to clear selected data that a user has selected from data displayed on the monitor 12A; a confirm button 13F that is press operated to confirm selected data that a user has selected from data displayed on the monitor 12A; and a cross-key 13G that is press operated to select information displayed on the monitor 12A.

Note that in the first basic embodiment, explanation follows of an example in which a left eye image G1 and a right eye image G2 are alternately displayed on the display device 12, in an embodiment in which a 3D picture is reproduced to visualize as a 3D viewing image by alternately driving liquid crystal shutters such that the liquid crystal shutter of the right eye of the liquid crystal shutter glasses 14 is in a transparent state when the left eye image G1 is being displayed, and the left eye of the liquid crystal shutter glasses 14 is in a transparent state when the right eye image G2 is being displayed. Note that in the first basic embodiment explanation is given of an image reproduction processing device that reproduces a 3D picture using the liquid crystal shutter glasses 14, however there is no limitation thereto. For example, application may be made to reproduction of a 3D picture using polarized filter glasses, or application may be made to an image reproduction processing device that reproduces a 3D picture using a non-glasses method. In the first basic embodiment, a 3D video editing routine, described later, is executed by an extended press of the reproduction start button 13B (for example press operation of 1 second or longer).

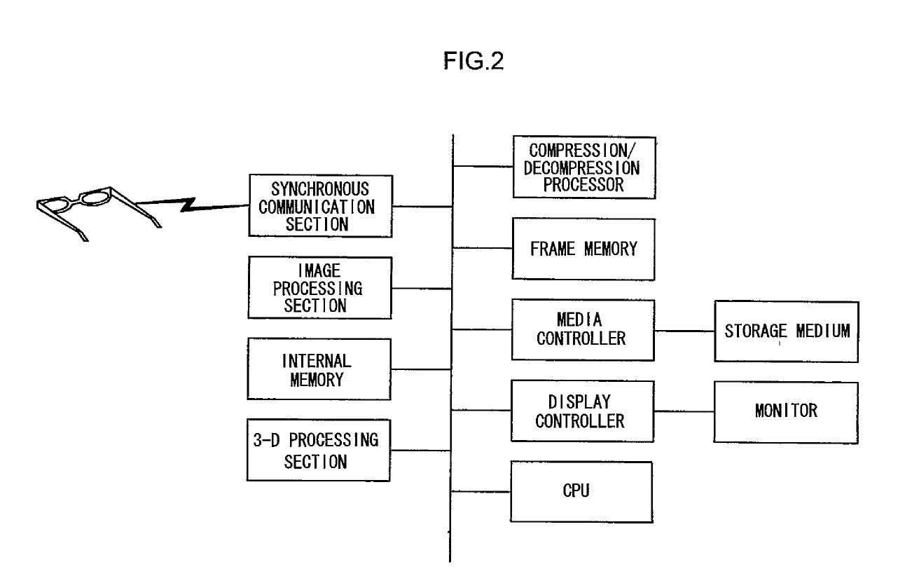

FIG. 2 is a block diagram illustrating a schematic configuration of the display device 12 side of the image reproduction processing equipment 10 according to the first basic embodiment.

The display device 12 is equipped with a synchronous communication section 16, an image processing section 18, a compression/decompression processor 20, a frame memory 22, a media controller 24, an internal memory 26, a 3D processing section 28, a display controller 30 and a CPU 32, with these mutually connected together through a BUS. A recording medium 34 is also connected to the media controller 24, and the monitor 12A is connected to the display controller 30. An operation section 13 is also connected to the CPU 32.

The synchronous communication section 16 transmits and receives a signal for synchronizing driving of the left and right liquid crystal shutters of the liquid crystal shutter glasses 14 with display of the respective images for the left eye and the right eye on the display device 12.

The image processing section 18 performs various types of image processing on image data expressing images to be displayed, such as white balance correction, gradation correction, sharpness correction and color correction.

The compression/decompression processor 20 performs compression processing with a compression format such as for example JPEG or MPEC on image data that has been processed by the image processing section 18 to generate a 3D viewing image file F0, and performs processing to decompress compressed image data during reproduction. The image file F0 includes image data of the left eye image G1 and the right eye image G2, and includes associated data such as the base line length, angle of convergence, and date and time of image capture, as well as viewpoint data expressing a viewpoint position, based on for example an Exif format.

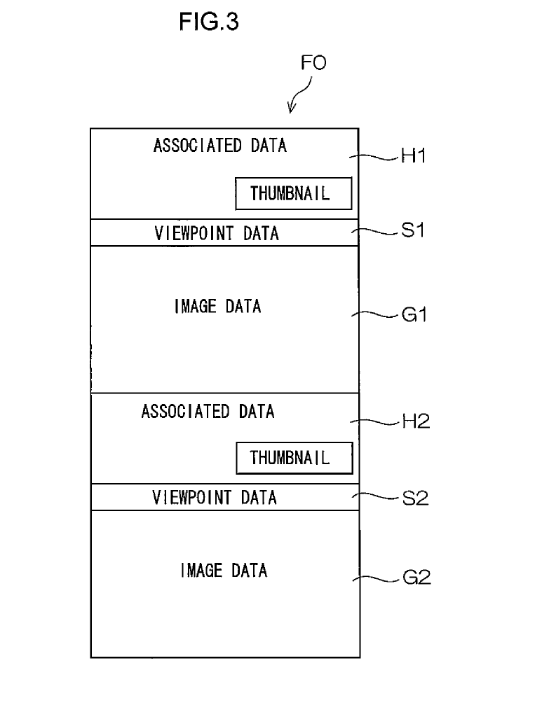

FIG. 3 is a diagram illustrating a file format of a 3D viewing image file. The 3D viewing image file F0 is stored with associated data H1 of the left eye image G1, viewpoint data S1 of the left eye image G1, image data of the left eye image G1, associated data H2 of the right eye image G2, viewpoint data S2 of the right eye image G2, and image data of the right eye image G2. Moreover, although omitted from illustration, there is also data expressing the start and end positions of the data contained in front of and after the associated data, viewpoint data and image data regarding the left eye image G1 and the right eye image G2.

The associated data H1, H2 contains data of the image capture day, baseline length, angle of convergence of the left eye image G1 and the right eye image G2. The associated data H1, H2 also contains thumbnail images of the left eye image G1 and the right eye image G2. Note that for example a number of viewpoint positions allocated in sequence from the left hand side may be used as viewpoint data.

The frame memory 22 is working memory used when the image processing section 18 performs various processing on the image data.

The media controller 24 accesses the storage medium 34 and controls writing and reading of for example image files.

The internal memory 26 stores for example data representing various settings in the display device 12, and a program executed by the CPU 32.

The 3D processing section 28 reads image data stored on the storage medium 34, and to cause a 3D viewing image to be displayed, uses the synchronous communication section 16 to synchronize to a synchronization signal obtained by communication with the liquid crystal shutter glasses 14, and controls the display controller 30 such that a 3D viewing image GR is displayed by alternately displaying the left eye image G1 and the right eye image G2. Moreover, in cases in which there is no parallax data recorded in the image data for each of the frames, the 3D processing section 28 performs processing to detect the main subject and to compute parallax for each of the frames. Moreover, the 3D processing section 28 is capable of adjusting the parallax of the left eye image G1 and the right eye image G2. Parallax here refers to the amount of displacement in pixel positions in the lateral direction, namely in the direction along the base line, between the left eye image G1 and the right eye image G2 for image subjects included in both the left eye image G1 and the right eye image G2. It is possible to appropriately set the 3D sensation of image subjects included in the 3D viewing image GR by adjusting the parallax.

During 3D viewing the display controller 30 alternately displays the left eye image G1 and the right eye image G2 on the monitor 12A by controlling the 3D processing section 28.

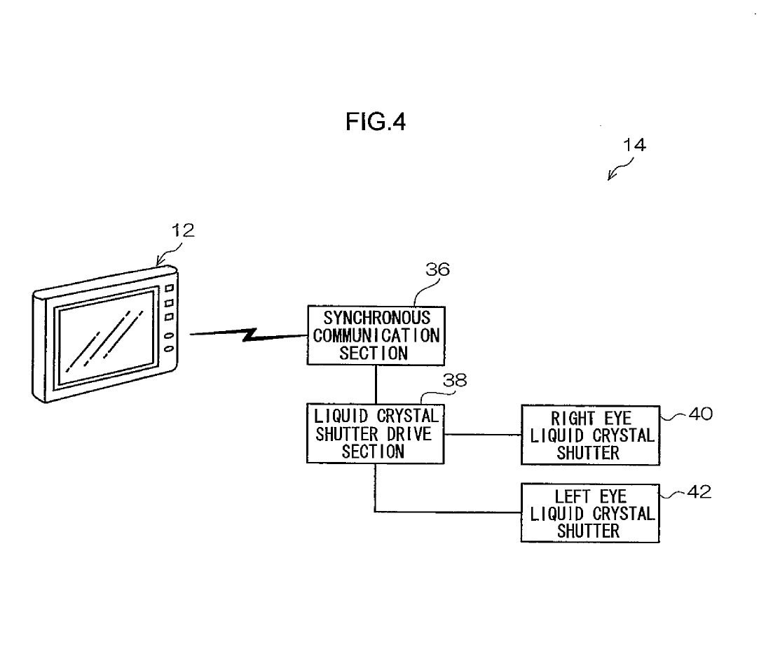

FIG. 4 is a block diagram illustrating a schematic configuration of the liquid crystal shutter glasses 14 side of the image reproduction processing equipment 10 according to the first basic embodiment.

The liquid crystal shutter glasses 14 are equipped with a synchronous communication section 36, a liquid crystal shutter drive section 38, a right eye liquid crystal shutter 40 and a left eye liquid crystal shutter 42.

The synchronous communication section 36 transmits a signal for synchronizing driving of the left and right liquid crystal shutters and respective display on the display device 12 of the left and right images.

The liquid crystal shutter drive section 38 synchronizes to the synchronization signal obtained by communication of the synchronous communication section 36 with the display device 12, and controls diving of the right eye liquid crystal shutter 40 and the left eye liquid crystal shutter 42. The right eye liquid crystal shutter 40 is thereby placed in a transparent state and the left eye liquid crystal shutter 42 in a blocking state when the left eye image G1 is displayed on the monitor 12A of the display device 12, and the left eye liquid crystal shutter 42 is thereby placed in a transparent state and the right eye liquid crystal shutter 40 in a blocking state when the right eye image G2 is being displayed on the monitor 12A of the display device 12, and a 3D viewing image is reproduced.

In the display device 12 configured as described above, a 3D video editing routine is executed by the CPU 32. Note that a program of the 3D video editing routine is pre-stored in the internal memory 26.

3D Video Editing Routine

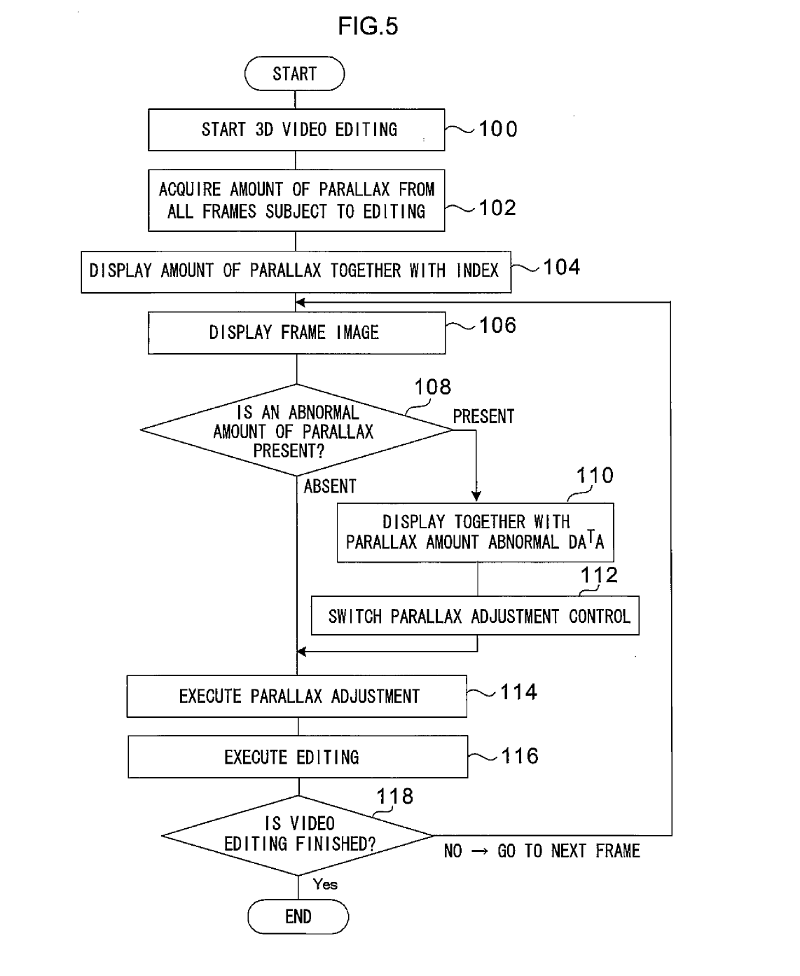

FIG. 5 is a flow chart illustrating a 3D video editing routine. Note that to avoid confusion, explanation follows regarding a case in which one option has already been specified by a user on an editing menu of plural predetermined options, such as cut, combining, resize, crop, rotate, color shading correction, overlay image (still image/video image/text etc.), frame rate conversion, interlace conversion, reverse, fade-in/fade-out, mosaic, format conversion etc.

At step 100, 3D video editing is started on input of an instruction to start editing a 3D video through the reproduction start button 13B, and processing proceeds to step 102. At step 102, an amount of parallax is acquired by the 3D processing section 28 based on the left eye image G1 and the right eye image G2 of the image file F0 configuring video data (a succession of frames) that is the target for editing and is stored in the storage medium 34. A first and second parallax amount acquisition routine are executed here, and the 3D processing section 28 performs the following processing.

Acquisition of Parallax Amount

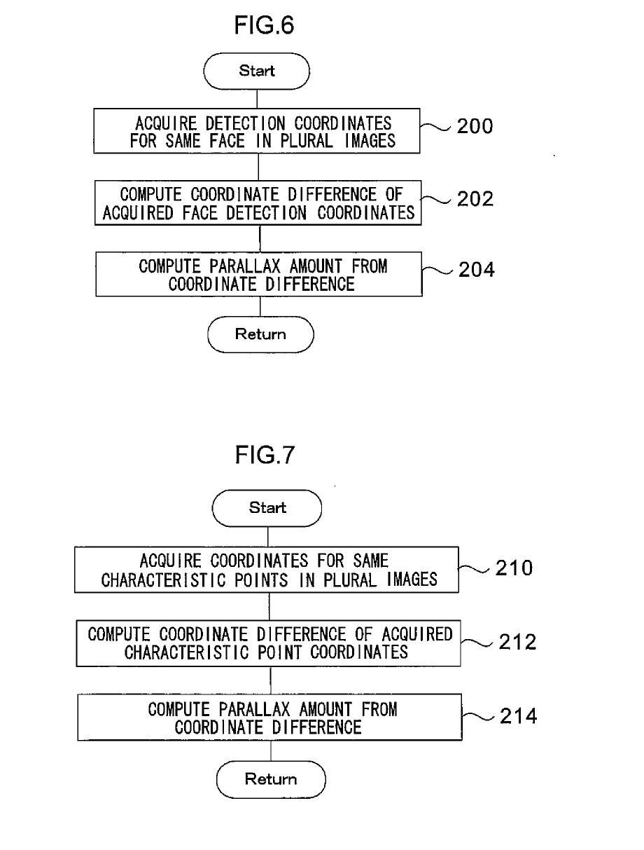

FIG. 6 is a flow chart illustrating a first parallax amount acquisition routine. The 3D processing section 28 firstly detects face regions of the same person in respective plural images, namely in the left eye image G1 and the right eye image G2 of the image file F0 stored in the storage medium 34, acquires face detection coordinates representing the coordinates of these face regions (step 200), computes a coordinate difference of the acquired face detection coordinates (step 202), and computes a parallax amount from the coordinate difference (step 204).

FIG. 7 is a flow chart of a second parallax amount acquisition routine. The 3D processing section 28 firstly respectively detects the same object in plural images, namely in the left eye image G1 and the right eye image G2 of the image file F0 stored in the storage medium 34, acquires characteristic point coordinates that are coordinates of characteristic points that identify that object (step 210), computes a coordinate difference of the acquired characteristic point coordinates (step 212), and computes a parallax amount from the coordinate difference (step 214). Then, the first and second parallax amount acquisition routines are ended, and processing proceeds to step 104 illustrated in FIG. 5.

Display of Parallax Amount

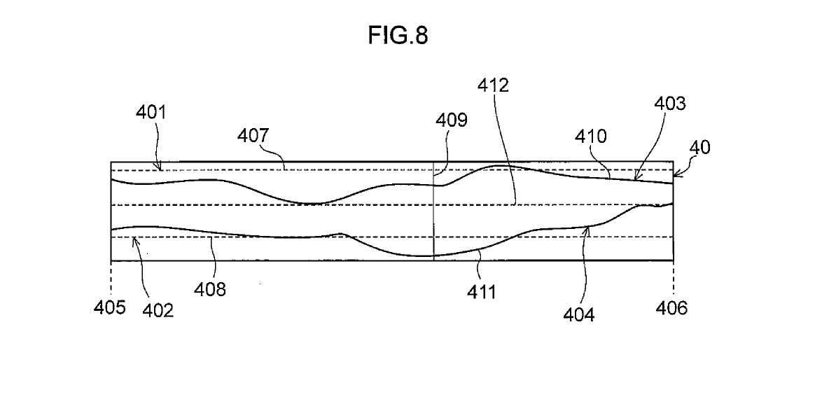

At step 104, the parallax amount obtained from the processing of step 102 and an index to determine whether or not the parallax amount is abnormal is comparably displayed on the monitor 12A, and then processing proceeds to step 106. FIG. 8 illustrates an example of a state in which a parallax amount and an index are comparably displayed on the monitor 12A. As illustrated in FIG. 8, in the monitor 12A of the display device 12 according to the present exemplary embodiment, a parallax amount display screen 40, including an indented side permissible limit line 401 (a straight line image indicating the maximum value of the permissible limit range) and a projection side permissible limit line 402 (straight line indicating the minimum value of the permissible limit range) that delimit the permissible limit range of parallax amount for objects (imaging subjects) symmetrical in the depth direction in a frame is displayed on the monitor 12A. Then a far side parallax amount graph 403 indicating changes with time in a parallax amount 410 of an indentation side object that is the far side object of the symmetrical objects, and a near side parallax amount graph 404 indicating changes with time in a parallax amount 411 of a projection side object that is the near side object of the symmetrical objects, are also overlaid and displayed on the parallax amount display screen 40 comparably with the indented side permissible limit line and the projection side permissible limit line. A marker is also displayed overlaid on the parallax amount display screen 40 at the location corresponding to the parallax amount based on the frame currently displayed on the monitor 12A. Thus the position of the marker changes according to the progression of frame display on the monitor 12A. In the example in FIG. 8, the marker moves from a left end 405 of the parallax amount display screen 40 (a position indicating the video reproduction start point) to a right end 406 (a position indicating the video image reproduction end point) at the same speed as the frame display speed. Moreover, in the example illustrated in FIG. 8, a vertical line 409 (marker, current display position) is applied as the marker that vertical cuts across an indentation side parallax permissible limit line 407, a projection side parallax permissible limit line 408, the far side parallax amount graph 403, and the near side parallax amount graph 404, however there is no limitation thereto. Any marker may be used that is capable of marking a screen state to enable, at least for the far side parallax amount graph and the near side parallax amount graph, the position corresponding to the parallax amount based on the frame being displayed on the monitor 12A at the current point in time to be visibly identified. The reference symbol 412 indicates a cross point.

By thus displaying the far side parallax amount graph and the near side parallax amount graph overlaid on the parallax amount display screen 40, a user (for example a 3D image editor) is able to determine when at least one of the far side parallax amount graph or the near side parallax amount graph has exceeded the parallax amount permissible limit range disposed between the indented side permissible limit line and the projection side permissible limit line which should encompass the graphs, and can determine when at least one of the far side parallax amount graph or the near side parallax amount graph has not exceeded the parallax amount permissible limit range disposed between the indented side permissible limit line and the projection side permissible limit line which should encompass the graphs. Note that the permissible limit range changes according to the anticipated display size of the frame, and so when the anticipated display size changes, the results of such change may be reflected in the far side parallax amount graph and the near side parallax amount graph.

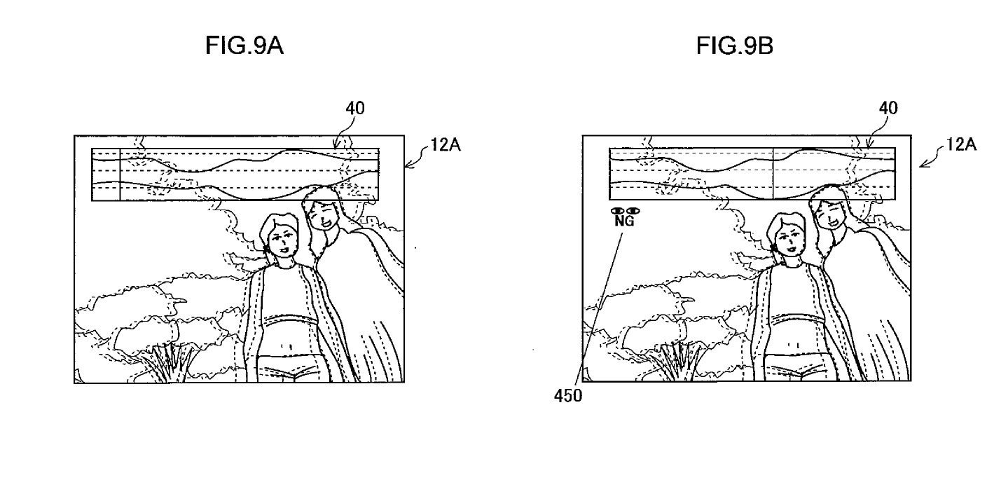

At step 106, as illustrated in the examples of FIG. 9A and FIG. 9B, a frame including video data of an editing subject is displayed on the monitor 12A, and the parallax amount display screen 40 is overlaid and displayed on a portion of the frame.

In the next step 108, determination is made as to whether or not the parallax amount acquired by the 3D processing section 28 for the frame displayed on the monitor 12A is abnormal, and processing proceeds to step 110 in cases in which abnormal determination has been made, and processing proceeds to step 114 in cases in which not-abnormal determination has been made. At step 108, determination is made that parallax amount is abnormal based on one of whether or not (1) there is hunting on the parallax amount, (2) the parallax amount is within the permissible limit, or (3) the parallax adjustment subject has been lost and can no longer be detected.

(1) Determination of Presence or Absence of Hunting

At step 108, the CPU 32 executes the following first or second hunting presence/absence determination routines. Note that programs of the first and second hunting presence/absence determination routine are stored in advance in the internal memory 26.

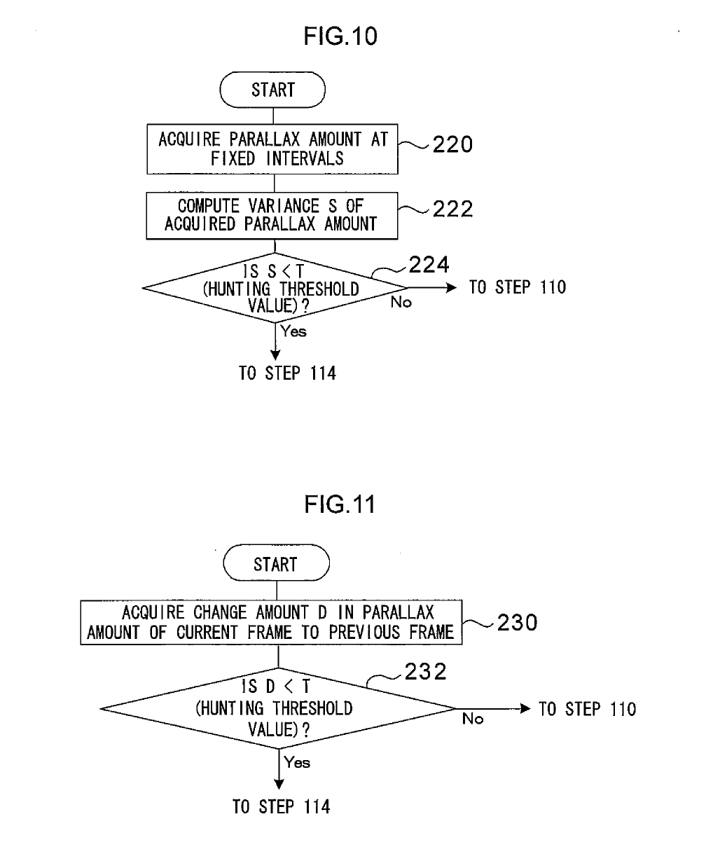

FIG. 10 is a flow chart illustrating the first hunting presence/absence determination routine. The CPU 32 acquires parallax amounts at a fixed interval obtained by the 3D processing section 28 (step 220), and computes a variance S in the acquired parallax amounts (step 222). The CPU 32 determines whether or not the variance S is smaller than a hunting threshold value T (S<T) (step 224). Processing proceeds to step 114 illustrated in FIG. 5 in cases in which S<T and it is determined that there is no hunting (that the parallax amount is not abnormal), and processing proceeds to step 110 in FIG. 5 in cases in which S is not <T and it is determined that hunting is present (that the parallax amount is abnormal).

FIG. 11 is a flow chart illustrating the second hunting presence/absence determination routine. The CPU 32 acquires a change amount D of the parallax amount between the current frame and the previous frame obtained by the 3D processing section 28 (step 230). Then the CPU 32 determines whether or not the change amount D is smaller than the hunting threshold value T (D<T) (step 232). Processing proceeds to step 114 in FIG. 5 in cases in which D<T and it is determined that there is no hunting (the parallax amount is not abnormal), and processing proceeds to step 110 in FIG. 5 in cases in which D is not <T and it is determined that there is hunting (the parallax amount is abnormal).

(2) Permissible Limit Determination of Parallax

At step 108, the CPU 32 determines whether or not the parallax amount has reached a predetermined permissible limit value. This permissible limit value is a threshold value for the parallax amount representing when an object expressed in a 3D viewing image jumps out too far, or is indented too much. Processing proceeds to step 110 in cases in which the parallax amount has reached the permissible limit value, and processing proceeds to step 114 in cases in which the parallax amount has not reached the permissible limit.

(3) Parallax Adjustment Subject Determination

The CPU 32 may, at step 108, determine whether or not the parallax adjustment subject has been lost and can no longer be detected. The parallax adjustment subject is an object such as for example a face of a person that is positioned near to the center of the screen, and corresponds to plural characteristic points etc.

Determination is made here that the parallax adjustment subject has been lost in cases in which the CPU 32, for example, has not detected the parallax adjustment subject for 10 frames, and as control means, processing proceeds to step 110, and processing proceeds to step 114 directly when the parallax adjustment subject has been detected for 10 frames. Note that “10 frames” is merely an example, and another number of frames may be used. Parallax adjustment control is accordingly switched in cases in which the parallax adjustment subject is lost, enabling parallax adjustment of 3D video reproduction to be stabilized.

Display of Abnormal Parallax Data

At step 110, as in the example illustrated in FIG. 9B, abnormal parallax data 450 indicating that the parallax amount is abnormal (text indicating a parallax amount warning “NG” is illustrated in the example in FIG. 9B) is overlaid on the frame and displayed on the monitor 12A. A user is accordingly able to easily ascertain that the parallax amount based on the currently displayed frame is abnormal. Note that in the present exemplary embodiment, explanation has been given of an example in which visual indication is given, however there is no limitation thereto and audio indication may be given that the parallax amount is abnormal. Visual indication and audio indication may also be used together.

Switching of Parallax Adjustment Control

At the next step 112, the CPU 32 switches parallax adjustment control to a different control, and then processing proceeds to step 114. At step 112, processing of one or other of a first or second switching processing is executed.

As a first switching processing, the CPU 32 defines a parallax amount maximum change amount for each of the frames and sets this in the 3D processing section 28, thereby applying a limit to the change amount of parallax amount for each of the frames. Parallax adjustment is accordingly performed within a range of the parallax amount maximum change amount, enabling rapid changes in parallax amount to be suppressed, and thereby enabling parallax adjustment of 3D video reproduction to be stabilized.

Moreover, as a second switching processing, the CPU 32 skips parallax adjustment for the given frame (prohibits parallax adjustment for the given frame) and continues with the parallax adjustment of the previous frame. Namely, the parallax amount of the previous frame is used. Parallax adjustment can according be skipped in cases in which the parallax amount is abnormal, thereby enabling the parallax adjustment of 3D video reproduction to be stabilized.

At step 114, the CPU 32 causes the 3D processing section 28 to execute parallax adjustment, outputs the parallax amount adjusted left eye image G1 and the right eye image G2 to the display controller 30, and processing proceeds to step 116.

At step 116, the CPU 32 executes editing pre-specified by a user on the frame currently being displayed. Note that at step 116, editing is executed according to the user instructed operation for frames in single frame units, however there is no limitation thereto, and editing may be performed in bulk on plural frames.

At the next step 118, the CPU 32 determines whether or not a video reproduction stop instruction has been input with the reproduction stop button 13C, and the present routine is ended when affirmative determination has been made, and processing proceeds to the next frame when negative determination is made, and processing returns to step 106.

As described above, it is possible to ascertain simply and with high precision whether the parallax amount is abnormal by the image reproduction processing equipment 10 controlling so as to comparably display on the monitor 12A the parallax amount (the far side parallax amount graph and the near side parallax amount graph) and an index to determine whether or not the parallax is abnormal (the indented side permissible limit line, the projection side permissible limit line, and the marker) whilst also displaying the frame that is subjected to processing on the monitor 12A.

Moreover, due to being able to ascertain abnormal parallax amounts of frames configuring video data to be subjected to editing at a stage previous to actually performing the editing, the image reproduction processing equipment 10 is capable of easily correcting places where the parallax amount is abnormal.

Note that in cases in which hunting is detected, the CPU 32 may store hunting data in the storage medium 34 indicating the presence or absence of hunting after executing parallax adjustment (after completing step 108). This thereby enables hunting data to be used during video reproduction another time since hunting data indicating the presence or absence of hunting has been attached, enabling parallax adjustment to be performed stabling during repeat 3D video reproduction. Moreover, although explanation has been given of an example in which at step 104 one determination is executed out of (1) hunting presence or absence determination, (2) parallax amount permissible limit determination, or (3) parallax adjustment subject determination, two or all out of (1) to (3) may be performed.

### First Exemplary Embodiment

Explanation next follows regarding a first exemplary embodiment of the present invention that presupposes the above first basic embodiment. Note that the same reference numerals are allocated to similar locations to those described above, and detailed explanation thereof is omitted.

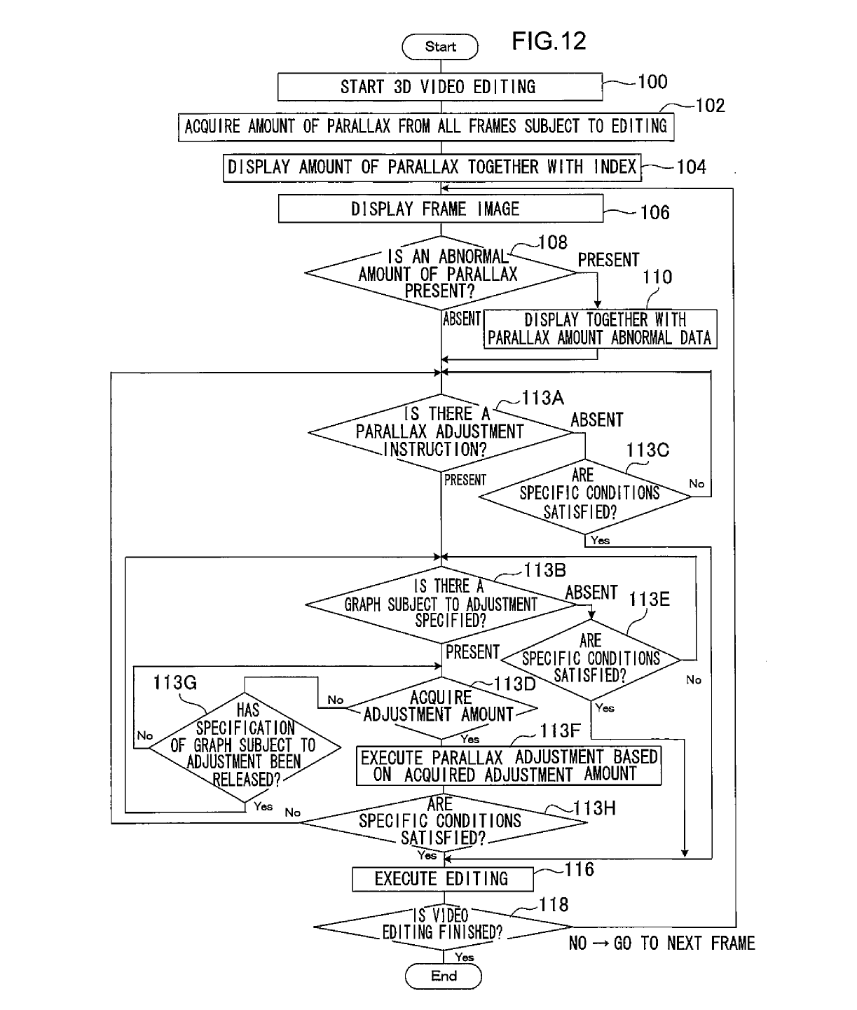

FIG. 12 is a flow chart illustrating a 3D video editing routine according to a first exemplary embodiment. Note that processing that is similar to that of the 3D video editing routine described above is allocated the same step numbers to in the above 3D video editing routine, and explanation is given of points that differ from the above 3D video editing routine.

In the 3D video editing routine according to the first exemplary embodiment, after the CPU 32 has executed the processing of step 110 illustrated in FIG. 12, processing proceeds to step 113A. At step 113A, determination is made as to whether or not a parallax amount adjustment instruction has been received by the operation section 13 serving as a reception means, and in cases in which affirmative determination is made then processing proceeds to step 113B, and processing proceeds to step 113C in cases in which negative determination is made. An instruction to perform parallax adjustment is, for example, implemented by press operating the menu button 13D of the operation section 13. Note that in cases in which affirmative determination is made at step 113A, one of the far side parallax amount graph or the near side parallax amount graph (for example the far side parallax amount graph) at the current point in time is displayed with a flashing display on the monitor 12A. For the display device 12 according to the first exemplary embodiment, the fact that the flashing displayed graph has been selected as being the parallax amount adjustment subject is notified to a user visually, however there is no limitation thereto, and a selected state at the current point in time of one of the graphs may be notified to a user by audibly. For example, speech of “the upper side graph is currently selected” may be output in cases in which the far side parallax amount graph is in a selected state, and speech of “the lower side graph is currently selected” may be output in cases in which the near side parallax amount graph is in a selected state. Moreover a combination of both visual indication and audio indication as described above may be used to notify a user as to which of the graphs is currently selected.

At step 113C, determination is made as to whether or not a predetermined condition is satisfied as a condition for not performing parallax adjustment (for example, a condition that a specific duration (for example 3 seconds) has elapsed since finishing executing the processing of step 108 or step 110. Processing proceeds to step 113A when negative determination is made, and processing proceeds to step 116 when affirmative determination is made.

At step 113B, determination is made as to whether or not a graph has been specified as an parallax amount adjustment subject from out of the far side parallax amount graph and the near side parallax amount graph, and processing proceeds to step 113D in cases in which affirmative determination is made, and processing proceeds to step 113E in cases in which negative determination is made. When a graph has been specified as the parallax amount adjustment subject by the processing of step 113B, the displayed state of the graph currently being displayed by flashing changes to a display state indicating that it has been specified as the parallax amount adjustment subject graph (for example a state in which it is displayed with dotted lines in a still display). Note that for the graph that is to be the parallax amount adjustment subject, for example, the far side parallax amount graph or the near side parallax amount graph may be selected by press operating the left-right direction key of the cross-key 13G, and then specified (confirmed) by press operating the confirm button 13F in the selected state. However, the specification method of the graph that is to be the parallax amount adjustment subject is not limited thereto. For example, a touch panel may be provided to the monitor 12A, and the graph that is to be the parallax amount adjustment subject may be specified by a user touching the graph in the flashing display state through the touch panel.

At step 113E, determination is made as to whether or not predetermined conditions are satisfied as conditions for not performing parallax adjustment (for example, a condition that a specific duration (for example 3 seconds) has elapsed since finishing executing the processing of step 113A). Processing proceeds to step 113B when negative determination is made, and processing proceeds to step 116 when affirmative determination is made.

At step 113D, determination is made as to whether or not a parallax amount adjustment amount has been acquired through the operation section 13. The parallax amount adjustment amount is, for example, acquired by press operation the upwards direction key or the downwards direction key of the cross-key 13G. Namely, the press operation amount of the upwards direction key or the downwards direction key of the cross-key 13G corresponds to the adjustment amount of the parallax amount, and the press operation amount to the upwards direction key or the downwards direction key of the cross-key 13G is acquired as the parallax amount adjustment amount. Moreover, in the display device 12 according to the second exemplary embodiment, when the upwards direction key or the downwards direction key of the cross-key 13G is press operated after specifying a graph that is to be the parallax amount adjustment subject, the graph specified as the parallax amount adjustment subject is deformed corresponding to the press operation. Specifically, the CPU 32 performs control so as to deform the graph that is the parallax amount adjustment subject corresponding to the press operation of the upwards direction key or the downwards direction key of the cross-key 13G by a deformation amount that is smaller by a predetermined ratio the further away in the left or right direction (to the video image start point side or the video image end point side) from the center of the marker vertical line (such that deformation is inversely proportional to distance from the marker).

Note that the parallax amount adjustment amount acquisition method is not limited to the method using press operation of the upwards direction key or the downwards direction key of the cross-key 13G. As another option, for example, a touch panel may be provided to the monitor 12A, and as the parallax amount adjustment amount a confirmed movement amount may be acquired by a user using the touch panel to touch a marker portion on a graph specified as the parallax amount adjustment subject, and then, after moving the touched portion to a specific position (for example a specific position within a range interposed between the indented side permissible limit line and the projection side permissible limit line), ceasing contact with the touch panel at a movement destination.

In cases in which affirmative determination is made at step 113D processing proceeds to step 113 as the processing means, and processing proceeds to step 113G in cases in which negative determination is made. At step 113G, determination is made as to whether or not the current specification of the graph as the parallax amount adjustment amount is released, with processing proceeds to step 113B in cases in which affirmative determination is made, and processing proceeds to step 113D in cases in which negative determination is made. Note that release of specification of the graph may, for example, be executed by press operation of a cancel button 13E.

At step 113F, parallax adjustment is executed by the 3D processing section 28 on the graph specified by the processing of step 113B based on the parallax amount acquired by the processing of step 113D. Thus the 3D processing section 28 performs parallax adjustment of the parallax amount acquired by the processing of step 113D for the frame being displayed at the current point in time, and adjusts the parallax amount for the frames preceding and following the frame being displayed at the current point in time. Specifically, for these frames, deformation is made in the same direction as the deformation direction of the marker portion in the graph that is the parallax amount adjustment subject at the current point in time, and parallax adjustment is executed such that the parallax amount becomes smaller as the deformation amount of the graph gradually gets smaller in a predetermined ratio on progression in the left or right direction (towards the video image start point side or the video image end point side) of the graph away from the marker at the center (so as to be inversely proportional to the distance from the marker). Thereby, not only is the parallax amount for the frame corresponding to the marker on the graph of the parallax amount adjustment subject (the currently displayed frame) adjusted, but also the parallax amount for the frames preceding and following this frame are also adjusted such that there is no unnatural feeling to the parallax amount.

Thus by executing the processing of steps 113B, 113D, 113F, for example in cases in which the far side parallax amount graph is not contained within the range encompassed by the indented side permissible limit line and the projection side permissible limit line (in cases positioned above the indented side permissible limit line), after specifying the far side parallax amount graph as the parallax amount adjustment subject, it is possible to make the portion of the marker in the far side parallax amount graph fall within the range encompassed by the indented side permissible limit line and the projection side permissible limit line by press operation of the downwards direction key of the cross-key 13G. Moreover, in cases in which the near side parallax amount graph is not contained within the range encompassed by the indented side permissible limit line and the projection side permissible limit line (in cases positioned below the projection side permissible limit line), after specifying the near side parallax amount graph as the parallax amount adjustment subject, it is possible to make the portion of the marker in the near side parallax amount graph fall within the range encompassed by the indented side permissible limit line and the projection side permissible limit line by press operation of the upwards direction key of the cross-key 13G.

In step 113H, determination is made as to whether or not predetermined conditions are satisfied as conditions for not performing parallax amount adjustment (for example, a condition that a specific duration (for example 3 seconds) has elapsed since finishing executing the processing of step 113F). Processing proceeds to step 113A when negative determination is made, and processing proceeds to step 116 when affirmative determination is made.

Note that explanation has been given in the first exemplary embodiment of an example in which parallax amount is adjusted according to operation by a user centered on a marker portion in the far side parallax amount graph or in the near side parallax amount graph, however there is no limitation thereto, and a location where the parallax amount permissible limit range is exceeded may be specified on the far side parallax amount graph or the near side parallax amount graph displayed on the parallax amount display image 40, and then parallax adjustment performed using the “first switching processing” explained in the first basic embodiment. In such cases, parallax adjustment using the “first switching processing” may be executed for the 3D processing section 28 in place of the processing of steps 113A to 113H of the 3D video editing routine according to the first exemplary embodiment. Note that in such cases too, by executing parallax adjustment such that the deformation amount of the graph gets gradually smaller in a predetermined proportion on progression in the left-right direction away from a center where the location of parallax adjustment is specified, not only is the parallax amount adjustment performed for the fame corresponding to the portion of the marker on the graph that is the parallax amount adjustment subject (the currently displayed frame), but the parallax amount for frames preceding or following this frame is also adjusted such that there is no unnatural feeling to the parallax amount.

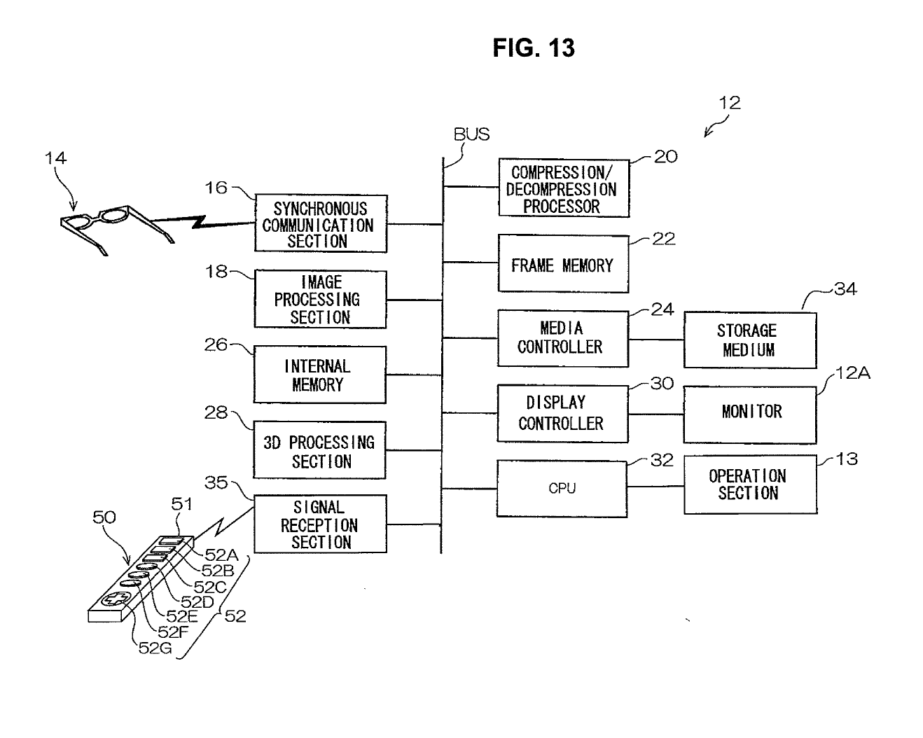

Note that explanation has been given in the first exemplary embodiment of an example in which instruction to perform parallax amount adjustment (step 113A), specification of the graph that is to be the parallax amount adjustment subject (step 113B), instruction of the adjustment amount of the parallax amount (step 113D), and specification of release of the adjustment subject graph (step 113G), are made by operation of the operation section 13 of the display device 12, however these may be performed using a remote controller 50 as illustrated for example in FIG. 13. The remote controller 50 is provided to a transmitter 51 that transmits a wireless signal to the display device 12. The remote controller 50 is also equipped with an operation section 52 configured including a power source button 52A similar to the power source button 13A for the display device 12, a reproduction start button 52B similar to the reproduction start button 13B for the display device 12, a reproduction stop button 52C similar to the reproduction stop button 13C for the display device 12, a menu button 52D similar to the menu button 13D for the display device 12, a cancel button 52E similar to the cancel button 13E for the display device 12, a confirm button 52F similar to the confirm button 13F for the display device 12 and a cross-key 52G similar to the cross-key 13G for the display device 12. The thus configured remote controller 50 transmits instructions received by operation of the operation section 52 as wireless signals to the display device 12.

The display device 12 is configured further including a signal reception section 35. The signal reception section 35 receives wireless signals transmitted by the remote controller 50, and is connected to a bus BUS. The CPU 32 is thereby able to ascertain various instructions contained in wireless signals received with the signal reception section 35. In the image reproduction processing equipment 10 configured in this manner, the CPU 32 is accordingly capable of ascertaining, as instructions received using the operation section 52 of the remote controller 50, instructions to perform parallax adjustment (step 113A), specification of the graph as the parallax amount adjustment subject (step 113B), instruction of adjustment amount of parallax amount (step 113D), and release of specification of the graph subject to adjustment (step 113G), and hence is capable of obtaining similar operation and advantageous effects to those of the first exemplary embodiment.

Moreover, in the first exemplary embodiment, “3D video editing” is execution of parallax adjustment combined with processing of step 116 of a 3D video editing routine, however there is no limitation thereto. For example “executing parallax amount adjustment” may be taken as “3D video editing”, with step 116 removed from the 3D video editing routine.

### Second Basic Embodiment

Explanation next follows regarding a second basic embodiment that is a premise to a second exemplary embodiment, described later. Note that the same reference numerals are applied to similar portions to those of the first exemplary embodiment, and detailed explanation thereof is omitted.

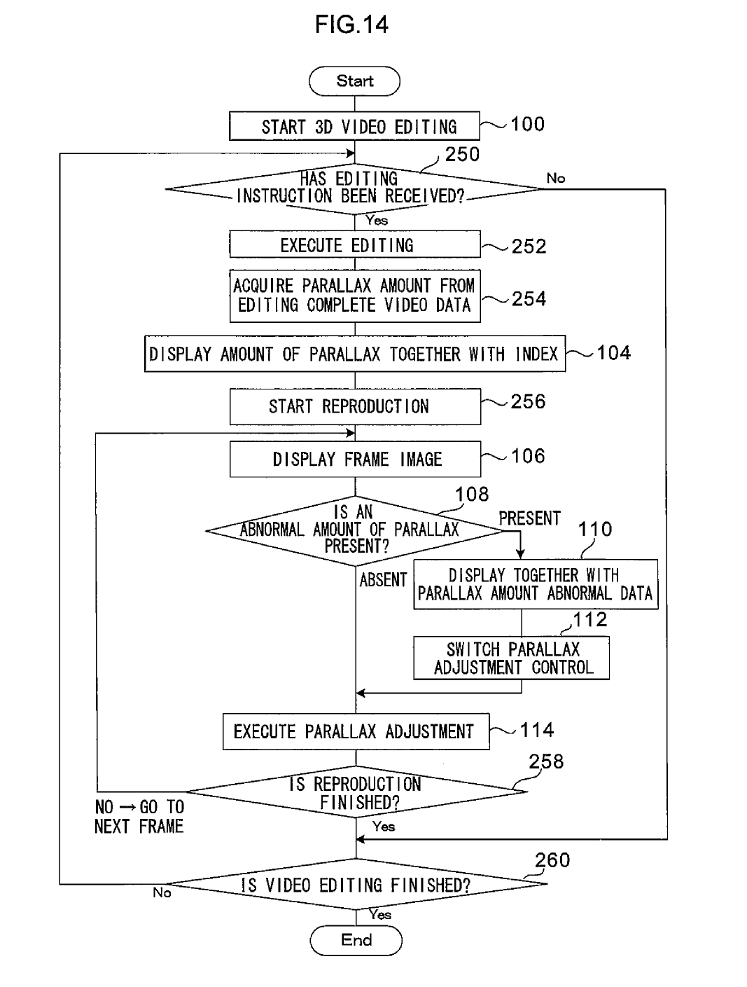

FIG. 14 is a flow chart illustrating a 3D video editing routine according to a second basic embodiment. Note that processing that is similar to that of the 3D video editing routine according to the first exemplary embodiment is allocated with the same step numbers and explanation omitted, with explanation given of points that differ in the 3D video editing routine according to the first exemplary embodiment.

In the 3D video editing routine according to the second basic embodiment, after the CPU 32 has executed the processing of step 100 as illustrated in FIG. 14, processing proceeds to step 250. At step 250, an instruction of an editing menu is received via the operation section 13. The editing menu instruction by a user at step 250 is any of plural predetermined editing menu options, such as cut, combining, resize, crop, rotate, color shading correction, overlay image (still image/video image/text etc.), frame rate conversion, interlace conversion, reverse, fade-in/fade-out, mosaic, format conversion etc.

At the next step 252, processing proceeds to step 254 after performing editing according to an editing menu received by the processing of step 250. At step 254, after the parallax amounts have been acquired for the 3D processing section 28 for subjects of each of all the frames configuring the editing complete video data that has been edited by the processing of step 252, processing then proceeds to step 104. Here the first or the second of the parallax amount acquisition routine explained in the first exemplary embodiment is executed.

The CPU 32 proceeds to step 256 after the processing of step 104 has been executed. At step 256, 3D video image reproduction is started with the editing-complete video data that has been edited by the processing of step 252 as the subject.

The CPU 32 executes the processing of step 114, and then processing proceeds to step 258 where determination is made as to whether or not a predetermined condition (for example a condition that an instruction to stop video reproduction has been input with the reproduction stop button 13C, or a condition that reproduction has been completed for all frames configuring the editing-complete video data that has been edited by the processing of step 252) has been satisfied as a condition to end 3D video reproduction, and processing returns to step 106 in cases of negative determination, and processing proceeds to step 260 in cases of affirmative determination. At step 260, determination is made as to whether or not a predetermined condition (for example a condition that a specific period of time has elapsed since finishing 3D video reproduction) has been satisfied as a condition to end the 3D video editing routine, and processing returns to step 250 when negative determination is made and the present routine is ended when affirmative determination is made.

As described above, in the image reproduction processing equipment 10 according to the second basic embodiment, due to being able to ascertain abnormal parallax amounts in a frame configuring editing-complete video data after editing has actually been executed, it is possible to perform re-editing including correcting locations where there is an abnormal parallax amount.

### Second Exemplary Embodiment

Explanation follows regarding a second exemplary embodiment of the present invention that presupposes the above second basic embodiment. Note that the same reference numeral are allocated to the same portions as described above, and further detailed explanation thereof is omitted.

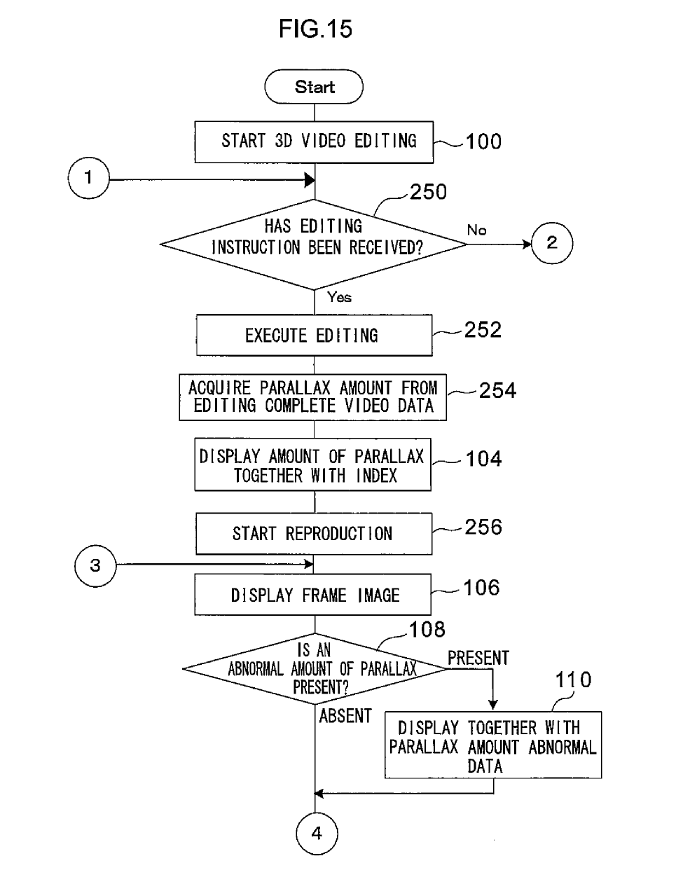

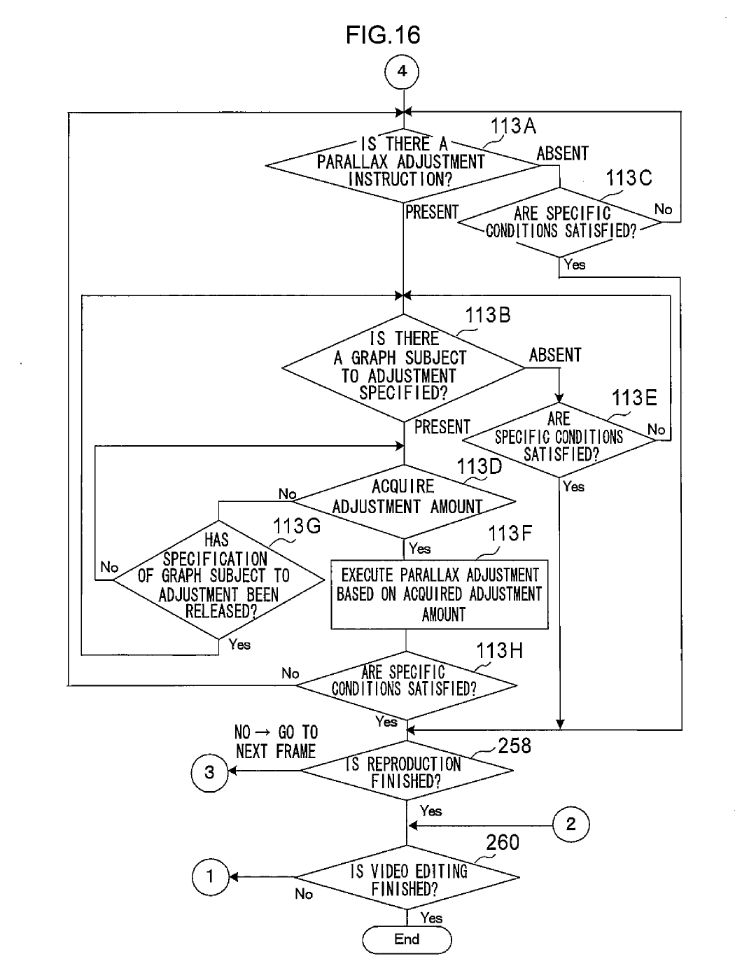

FIG. 15 and FIG. 16 are flow charts illustrating 3D video editing routines according to the second exemplary embodiment. Note that in the following, the same step numbers are appended to processing that is similar to the 3D video editing routine according to the first exemplary embodiment, and to processing of the 3D video editing routine of the second basic embodiment, and further explanation thereof is omitted, with explanation focusing on points that differ from the 3D video editing routine according to the second exemplary embodiment.

The 3D video editing routine according to the second exemplary embodiment differs from the 3D video editing routine of the second basic embodiment in the point that steps 112 and 114 are eliminated, and in the point that steps 113A to 113H of the 3D video editing routine according to the first exemplary embodiment are provided.

Processing proceeds to step 113A when negative determination is made at step 108, and processing proceeds to step 110 when affirmative determination is made at step 108. Processing proceeds to step 113A when the CPU 32 has finished executing the processing of step 110, the processing of steps 113A to 113H is executed. Processing proceeds to step 258 when affirmative determination is made at steps 113C, 113E, 113H.

Note that although explanation has been given in the second exemplary embodiment of an example of an embodiment in which the parallax amount is adjusted according to operation of a user centered on a marker portion at a far side parallax amount graph or a near side parallax amount graph, there is no limitation thereto, and configuration may be made such that a location may by specified where the parallax amount permissible limit range is exceeded for the far side parallax amount graph or the near side parallax amount graph as displayed in the parallax amount display screen 40, and parallax adjustment performed using the “first switching processing” as explained in the first basic embodiment.

Moreover, although explanation has been given in the second exemplary embodiment of an example of an embodiment in which performing of parallax amount adjustment is instructed by operation of the operation section 13 of the display device 12 (step 113A), the graph that is to be subject to parallax amount adjustment is specified (step 113B), instruction of the amount adjustment of the parallax amount (step 113D), and release of the specification of the graph subject to adjustment is released (step 113G), these operations may be performed by for example using the remote controller 50 illustrated in FIG. 13.

Moreover, although in the second exemplary embodiment the “3D video editing” is execution of parallax amount adjustment combined with processing of step 252 of the 3D video editing routine, there is no limitation thereto. For example “executing parallax adjustment” may be taken as “3D video editing”, with step 252 removed from the 3D video editing routine. In such cases, this results in executing processing at step 254 to acquire the parallax amount from video data, in place of from the editing-complete video data.

### Third Basic Embodiment

Explanation next follows regarding a third basic embodiment that is a premise to a third exemplary embodiment of the present invention, described later. Note that the same reference numerals are appended to similar portions to in the first and second exemplary embodiments, and further detailed explanation is omitted thereof.

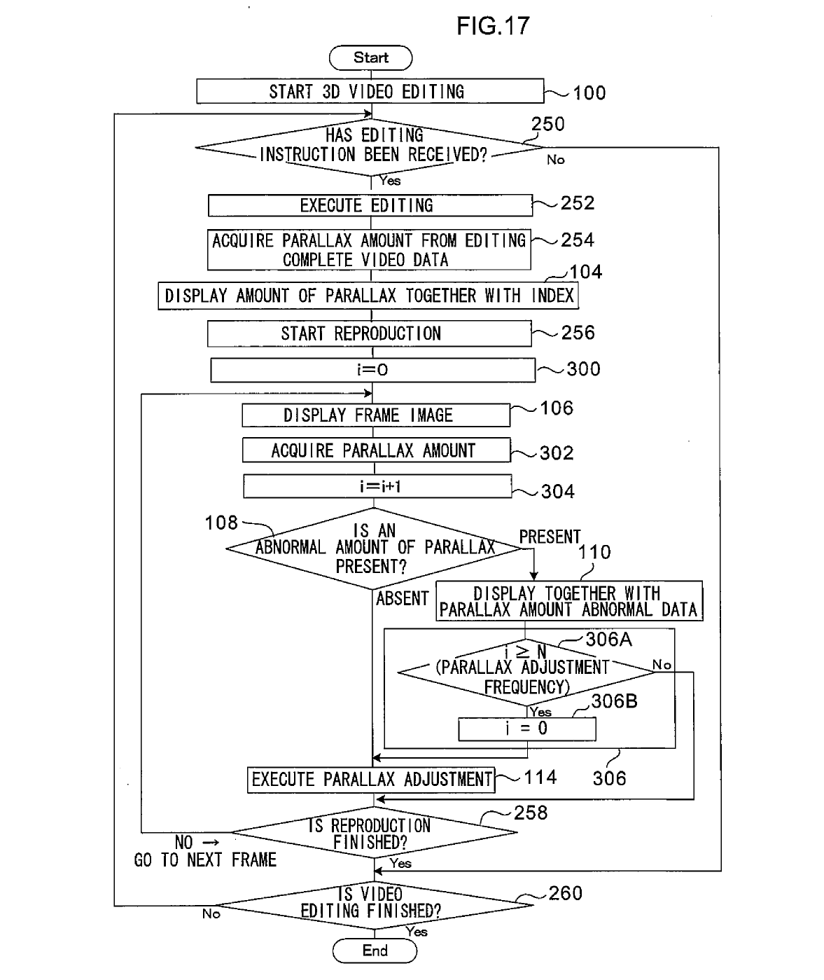

FIG. 17 is a flow chart illustrating a 3D video editing routine according to the third basic embodiment. Note that in the following, processing that is similar to that of the 3D video editing routine according to the second exemplary embodiment is allocated the same step numbers and explanation thereof is omitted, with explanation following of points that differ from the 3D video editing routine according to the second exemplary embodiment.

In the 3D video editing routine according to the third exemplary embodiment, after the CPU 32 has executed the processing of step 256 illustrated in FIG. 17, processing proceeds to step 300. At step 300, after setting an index number i=0, processing proceeds to step 106, and after the processing of step 106 has been executed, processing then proceeds to step 302. At step 302, processing proceeds to step 304 after the parallax amount for the fame being displayed at the current point in time has been acquired. At step 304, i is incremented by 1 (i=i+1) and then processing proceeds to step 108.

After the processing of step 110 has been executed by the CPU 32, processing proceeds to step 306A. At step 306A, determination is made as to whether or not the index number i is a parallax adjustment frequency N or greater (i≧N). Processing proceeds to step 306B in cases in which i≧N, where processing then proceeds to step 114 after setting i=0, and in cases in which i is not ≧N, processing then proceeds to step 258 by skipping step 114.

Accordingly, steps 106, 302, 108, 110, 306 (step 306A) and 258 are repeatedly executed in cases in which the index number i is less than N, and parallax adjustment (step 114) is not performed. Moreover, when the index number i reaches N, processing proceeds to step 114 through steps 108, 110, 306 (step 306A, 306B), and hence parallax adjustment is executed. Consequently, in cases in which there is abnormal parallax, the parallax adjustment is not performed every frame but is instead performed only once every N frames, thereby enabling the frequency of parallax adjustment to be reduced, and changes in parallax adjustment to be made smoothly.

### Third Exemplary Embodiment

Explanation next follows regarding a third exemplary embodiment of the present invention that presupposes the above third basic embodiment. Note that the same reference numerals are appended to similar portions to in the above, and further detailed explanation thereof is omitted.

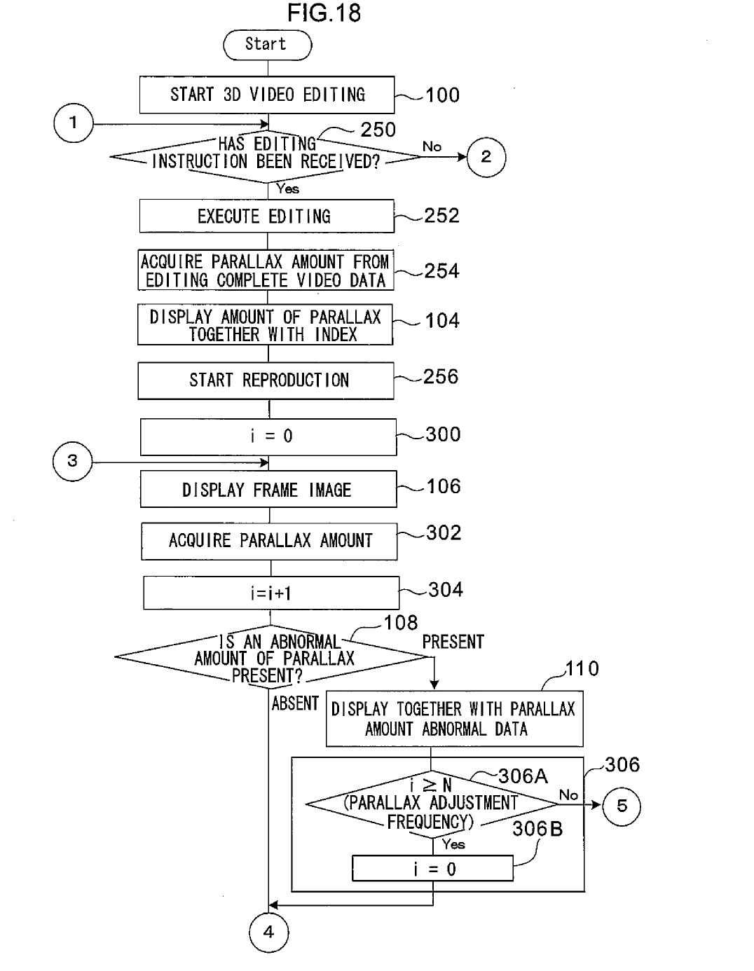

FIG. 18 and FIG. 19 are flow charts illustrating 3D video editing routines according to the third exemplary embodiment. Note that processing that is similar to that of the 3D video editing routine according to the second exemplary embodiment and to that of the 3D video editing routine according to the third basic embodiment is allocated with the same step numbers and explanation omitted, with explanation given of points that differ from the 3D video editing routine according to the third basic embodiment.

The 3D video editing routine according to the third exemplary embodiment differs from the 3D video editing routine according to the third basic embodiment in that step 114 is eliminated, and steps 113A to 113H of the 3D video editing routine according to the first exemplary embodiment are provided.

Processing proceeds to step 113A when negative determination is made at step 108, and processing proceeds to step 110 when affirmative determination is made at step 108. Processing proceeds to step 113A when the CPU 32 has finished executing the processing of step 306B, and the CPU 32 executes the processing of steps 113A to 113H. Processing proceeds to step 258 when affirmative determination is made at steps 113C, 113E, 113H.

Note that explanation has been given in the third exemplary embodiment of an example in which parallax amount is adjusted according to operation by a user centered on a marker portion in the far side parallax amount graph or in the near side parallax amount graph, however there is no limitation thereto, and a location may be specified where the parallax amount permissible limit range is exceeded for the far side parallax amount graph or the near side parallax amount graph displayed on the parallax amount display image 40, and then parallax adjustment performed using the “first switching processing” explained in the first basic embodiment.

Moreover, although explanation has been given in the third exemplary embodiment of an example of an embodiment in which performing of parallax amount adjustment is instructed by operation of the operation section 13 of the display device 12 (step 113A), the graph that is to be subject to parallax amount adjustment is specified (step 113B), the amount adjustment of the parallax amount is instructed (step 113D), and release of the specification of the graph subject to adjustment is released (step 113G), these operations may be performed by for example using the remote controller 50 illustrated in FIG. 13.

Moreover, although in the third exemplary embodiment the “3D video editing” is execution of parallax amount adjustment combined with processing of step 252 of the 3D video editing routine, there is no limitation thereto. For example “executing parallax adjustment” may be taken as “3D video editing”, with step 252 removed from the 3D video editing routine. In such cases, this results in executing processing at step 254 to acquire the parallax amount from video data, in place of from editing-complete video data.

### Fourth Basic Embodiment

Explanation next follows regarding a fourth basic embodiment that is a premise to a fourth exemplary embodiment of the present invention described later. The same reference numerals are appended to similar portions to those of the first to third exemplary embodiments, and further detailed explanation thereof is omitted.

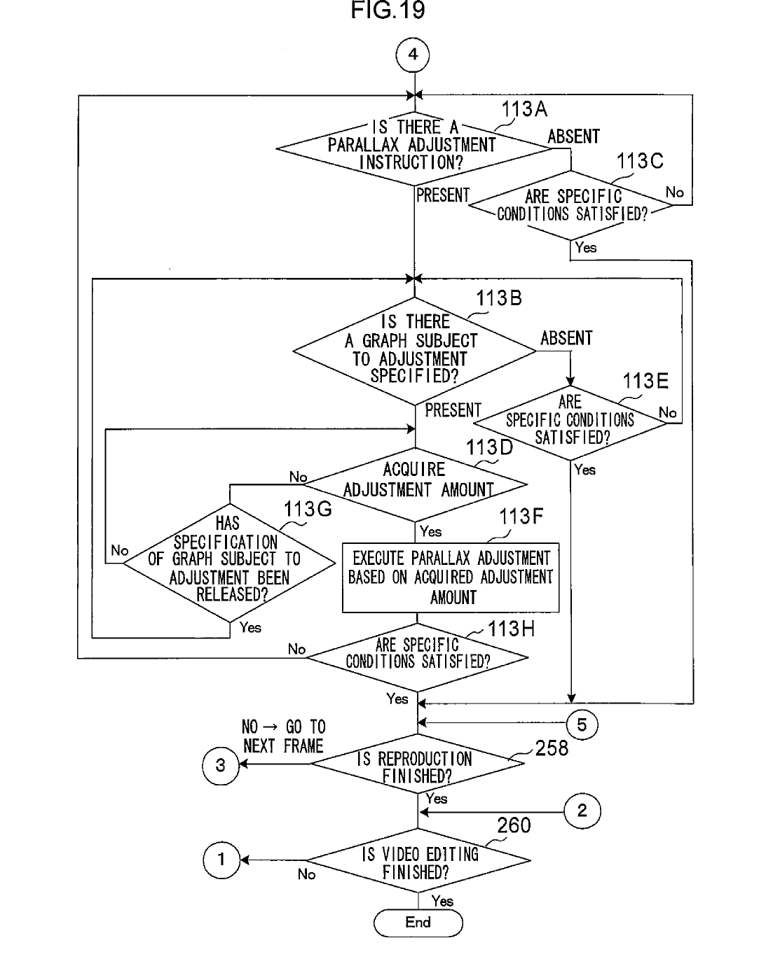

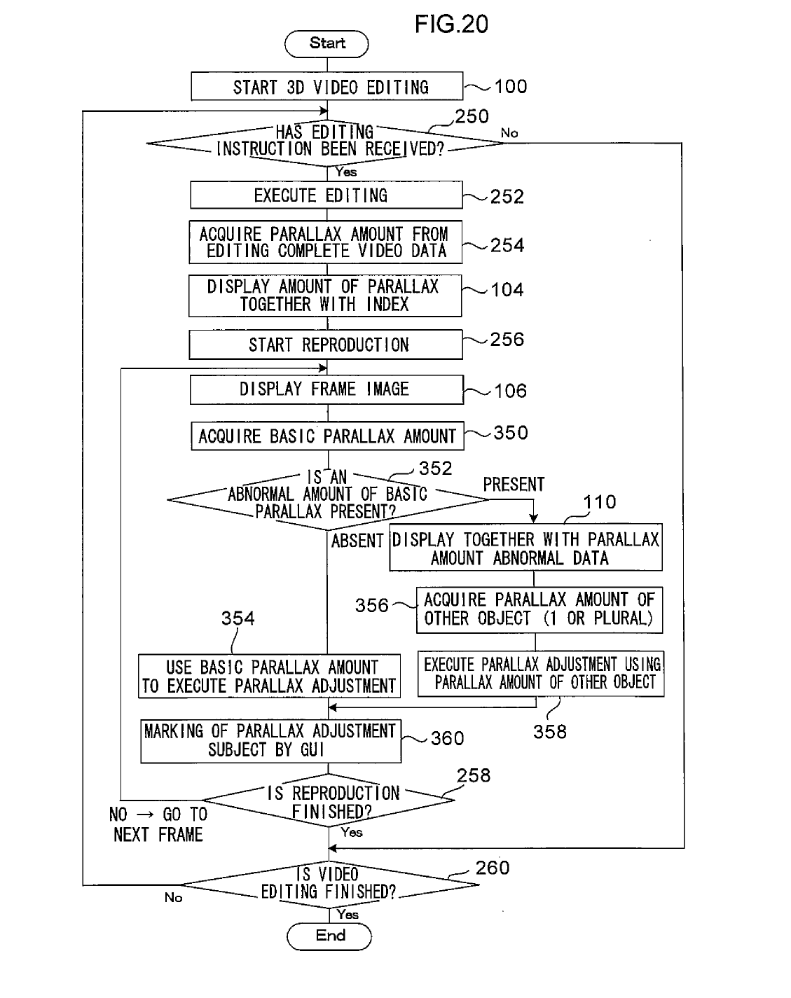

FIG. 20 is a flow chart illustrating a 3D video editing routine according to the fourth basic embodiment. Note that in the following processing that is similar to the 3D video editing routine according to the third exemplary embodiment is allocated the same step numbers and explanation thereof is omitted, and explanation is given of points that differ from the 3D video editing routine according to the third exemplary embodiment.

In the 3D video editing routine according to the fourth basic embodiment, after the CPU 32 has executed the processing of the step 106 as illustrated in FIG. 20, processing proceeds to step 350. At step 350, the basic parallax amount is acquired by the 3D processing section 28 based on the left eye image G1 and the right eye image G2 of the image file F0 stored on the storage medium 34, and then processing proceeds to step 352. The basic parallax amount means the parallax amount of a default object, for example the parallax amount of an object nearest to the center of the screen.

At step 352, determination is made as to whether or not the basic parallax amount acquired by the 3D processing section 28 is abnormal. Similar processing is executed here to that of step 108 illustrated in FIG. 18. Processing proceeds to step 110 when the basic parallax amount is abnormal, and processing proceeds to step 354 when not abnormal.

At step 354, the CPU 32 controls the 3D processing section 28 so as to execute the parallax adjustment using the basic parallax amount, and then processing proceeds to step 360. According to the processing of step 354, the 3D processing section 28 performs parallax adjustment using the basic parallax amount of the left eye image G1 and the right eye image G2, and outputs the parallax adjusted left eye image G1 and the right eye image G2 to the display controller 30.

However, after the CPU 32 has executed the processing of step 110 processing proceeds to step 356. At step 356, the parallax amount of another object is acquired by the 3D processing section 28, and processing proceeds to step 358. The other object corresponds, for example, to a face of a person other than the default object or the like.

At step 358, the 3D processing section 28 is controlled so as to execute parallax adjustment using the parallax amount of the other object. On such occasions, the 3D processing section 28 selects as the “other object” an “object in the vicinity of the default object in the Z direction” or “an object in the vicinity of the default object in 2-dimensional coordinates”, performs parallax adjustment using the parallax amount of the selected object, and outputs the parallax adjusted object to the display controller 30. Reference here is to 2-dimensional coordinates (X, Y) in the same plane as the left eye image G1 and the right eye image G2 in the image file F0 stored on the storage medium 34, and to the Z direction that is normal to this plane (the baseline).

Accordingly, the “object in the vicinity of the default object in the Z direction” is the closest object in 3D sensation to the default object, irrespective of the vicinity or otherwise in 2-dimensional coordinates. The 3D processing section 28 performs parallax adjustment using the parallax amount of this object, and is accordingly able to suppress rapid changes in the parallax amount, and as a result is able to perform stable parallax adjustment.

Moreover, the “object in the vicinity of the default object in 2-dimensional coordinates” is the object closest to the default object in the 2-dimensional coordinates, irrespective of the vicinity to the default object in 3D sensation. The 3D processing section 28 performs parallax adjustment using the parallax amount of this object, and is accordingly able to perform parallax adjustment with an object in the vicinity of the subject of parallax adjustment up till then, and as a result is able to perform stable parallax adjustment. Processing then proceeds to step 360 via the above processing.

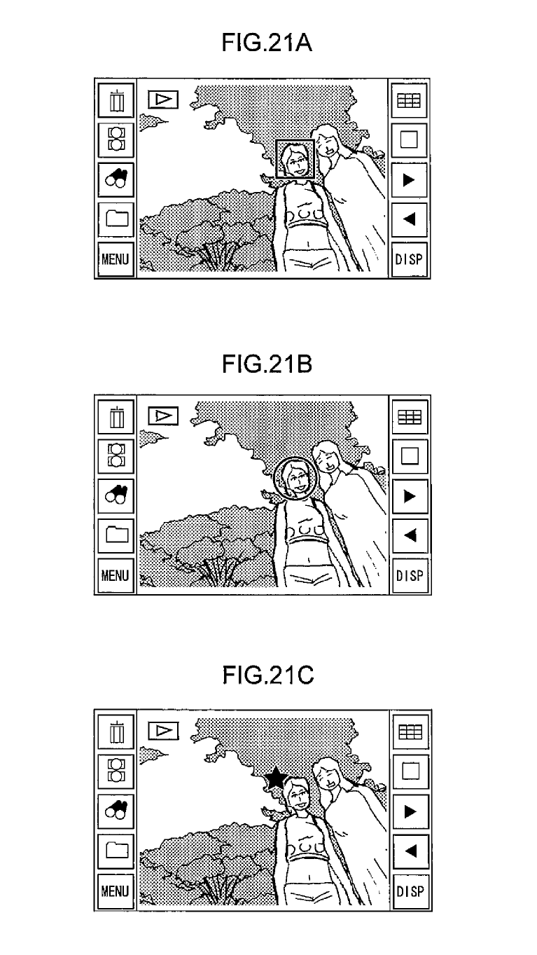

At step 360, the parallax adjustment subject is marked using a Graphical User Interface (GUI) and displayed on the monitor 12A, and processing proceeds to step 258. At this point the face of a person that is the parallax adjustment subject may, for example, be surrounded by a square such as the one illustrated in FIG. 21A, may be encircled by a circle such as the one illustrated in FIG. 21B, or may be appended with a star marker such as that illustrated in FIG. 21C.

At step 258, the CPU 32 determines whether or not instruction to stop video reproduction has been input with the reproduction stop button 13C, and ends processing of the present routine when affirmative determination is made, and proceeds to processing of the next frame when negative determination is made, with processing returning to step 106.

As described above, in the image reproduction processing equipment 10 of the fourth exemplary embodiment, even in cases in which the basic parallax amount of the default object is abnormal, or the default object has been lost, it is still possible to stabilize parallax adjustment of the 3D video reproduction due to switching the parallax adjustment subject to another object and then performing parallax adjustment.

### Fourth Exemplary Embodiment

Explanation follows regarding a fourth exemplary embodiment of the present invention that presupposes the above fourth basic embodiment. Note that the same reference numeral are allocated to the same portions as described above, and further detailed explanation thereof is omitted.

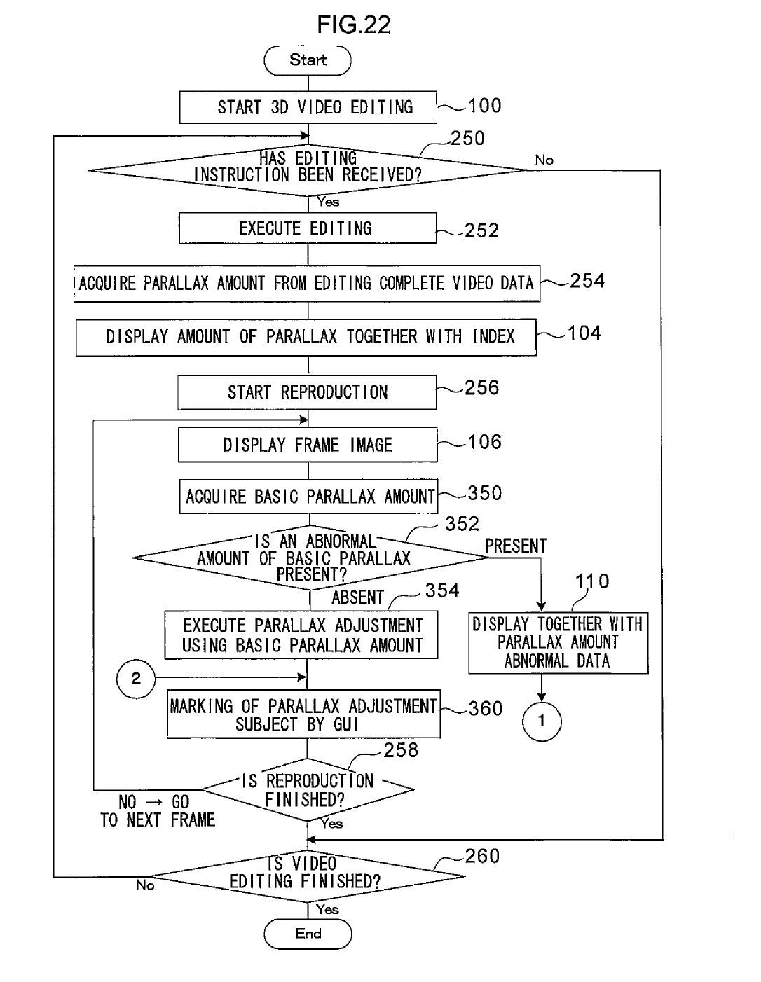

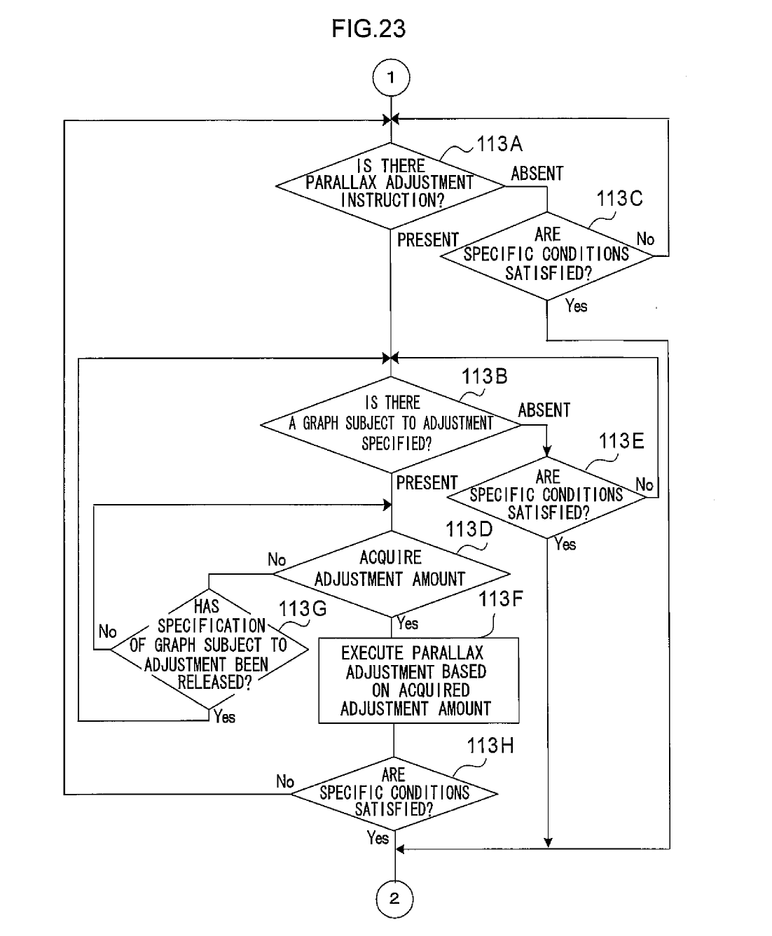

FIG. 22 and FIG. 23 are flow charts illustrating 3D video editing routines according to the fourth exemplary embodiment. Note that in the following, the same step numbers are appended to processing that is similar to the 3D video editing routine according to the third exemplary embodiment, and to processing of the 3D video editing routine of the fourth basic embodiment, and further explanation thereof is omitted, with explanation focusing on points that differ from the 3D video editing routine according to the fourth basic embodiment.

The 3D video editing routine according to the fourth exemplary embodiment differs from the 3D video editing routine of the fourth basic embodiment in the point that steps 356 and 358 are eliminated, and in the point that steps 113A to 113H of the 3D video editing routine according to the first exemplary embodiment are provided.

Processing proceeds to step 113A when the CPU 32 has finished executing the processing of step 110, and the CPU 32 executes the processing of steps 113A to 113H. Processing proceeds to step 360 when affirmative determination is made at steps 113C, 113E, 113H.

Note that although explanation has been given in the fourth exemplary embodiment of an example of an embodiment in which the parallax amount is adjusted according to operation of a user centered on a marker portion at a far side parallax amount graph or a near side parallax amount graph, there is no limitation thereto, and configuration may be made such that a location may by specified where the parallax amount permissible limit range is exceeded for the far side parallax amount graph or the near side parallax amount graph as displayed in the parallax amount display screen 40, and parallax adjustment performed using the “first switching processing” as explained in the first basic embodiment.

Moreover, although explanation has been given in the fourth exemplary embodiment of an example of an embodiment in which performing of parallax amount adjustment is instructed by operation of the operation section 13 of the display device 12 (step 113A), the graph that is to be subject to parallax amount adjustment is specified (step 113B), the adjustment amount of the parallax amount is instructed (step 113D), and release of the specification of the graph subject to adjustment is released (step 113G), these operations may be performed by for example using the remote controller 50 illustrated in FIG. 13.

Moreover, although in the fourth exemplary embodiment the “3D video editing” is execution of parallax amount adjustment combined with processing of step 252 of the 3D video editing routine, there is no limitation thereto. For example “executing parallax adjustment” may be taken as “3D video editing”, with step 252 removed from the 3D video editing routine. In such cases, this results in executing processing at step 254 to acquire the parallax amount from video data, in place of from editing-complete video data.

### Fifth Exemplary Embodiment

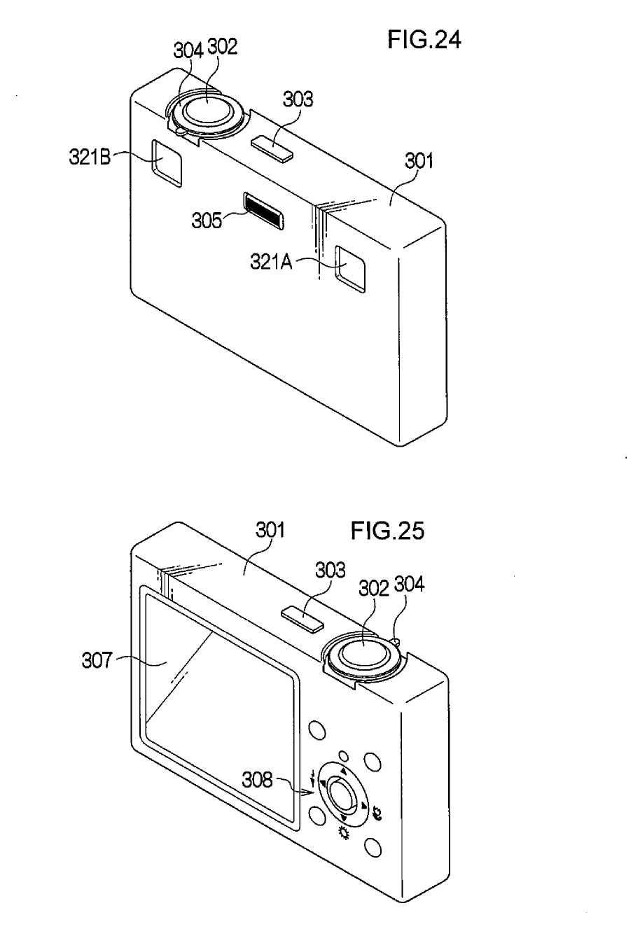

Explanation next follows regarding a fifth exemplary embodiment of the present invention, with reference to the drawings. FIG. 24 is a perspective view from the front side of a multi-lens camera 301 according to an exemplary embodiment of the present invention, and FIG. 25 is a perspective view from the back side thereof.

An upper portion of the multi-lens camera 301 is equipped with a release button 302, a power button 303 and a zoom lever 304. A flash 305 and lenses of two image capture sections 321A, 321B are disposed on the front face of the multi-lens camera 301. A liquid crystal monitor (referred to below simply as “monitor”) 307 for performing various types of display and various operation buttons 308 including buttons that function as the reproduction start button 13B and the reproduction stop button 13C explained in the first and second exemplary embodiments are disposed on the back face of the multi-lens camera 301.

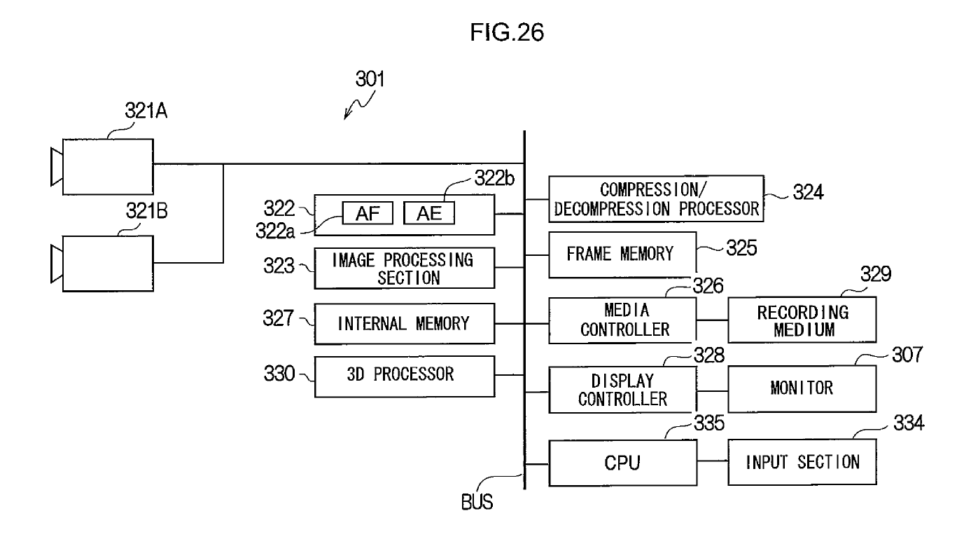

FIG. 26 is a schematic block diagram illustrating an internal configuration of the multi-lens camera 301. The multi-lens camera 301 is equipped with the two image capture sections 321A, 321B, an image capture controller 322, an image processing section 323, a compression/decompression processor 324, a frame memory 325, a media controller 326, an internal memory 327, a display controller 328, and a CPU 335, mutually connected together through a bus BUS. Moreover, a recording medium 329 is connected to the media controller 326 and a monitor 307 is connected to the display controller 328. Moreover, an input section 334 configured including the release button 302, the power button 303, the zoom lever 304 and the operation buttons 308 is connected to the CPU 335. Note that the image capture sections 321A, 321B are disposed looking in at an image subject at an angle of convergence so as to give a predetermined base line length. Data for the angle of convergence and base line length are stored in the internal memory 327.

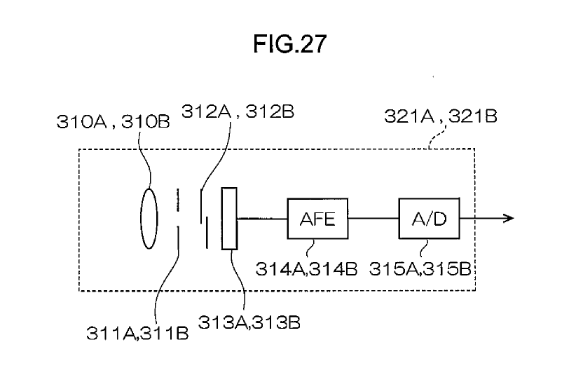

FIG. 27 is a figure illustrating a configuration of the image capture sections 321A, 321B. As illustrated in FIG. 27, the image capture sections 321A, 321B are respectively provided with lenses 310A, 310B, apertures 311A, 311B, shutters 312A, 312B, image pick-up devices 313A, 313B, analogue front ends (AFE) 314A, 314B, and A/D conversion sections 315A, 315B.

The lenses 310A, 310B are focus lenses that focus a subject at a focal point, and include plural function specific lenses such as zoom lenses for executing a zoom function. The position of the lenses 310A, 310B is adjustable with a lens drive section, not illustrated in the drawings, based on focusing data obtained by an AF processing section 322a of the image capture controller 322, and zoom data obtained in cases in which the zoom lever 304 illustrated in FIG. 24 and FIG. 25 is operated.

In the apertures 311A, 311B, adjustment of the aperture diameter is performed by an aperture drive section, not illustrated in the drawings, based on aperture number data obtained by an AE processing section 322b of the image capture controller 322.

The shutters 312A, 312B are mechanical shutters, and are driven by a shutter drive section, not illustrated in the drawings, according to a shutter speed obtained by the AE processing section 322b.

The image pick-up devices 313A, 313B have photoelectric surfaces with multiple photoreceptors arrayed in a two dimensional array, and analogue image pickup signals are acquired by subject light being focused on the photoelectric surfaces and photoelectric converted. Color filters are disposed on the front faces of the image pick-up devices 313A, 313B, with R, G, B colored filters arrayed in a regular pattern.

The AFE 314A, 314B take the analogue image pickup signals output from the image pick-up devices 313A, 313B, and perform noise reduction processing on the analogue image pickup signals, and perform gain adjustment on the analogue image pickup signals (referred to below as analogue processing).

In the A/D conversion sections 315A, 315B, the analogue image pickup signals that have been analogue processed by the AFE 314A, 314B are converted into digital signals. Note that the image expressed by the digital image data acquired by the image capture section 321A is taken as the left eye image G1, and the image data acquired by the image capture section 321B is taken as the right eye image G2.

The image capture controller 322 includes the AF processing section 322a and the AE processing section 322b as described above. The AF processing section 322a is operated by half depressing the release button 302, acquires distance data from a distance sensor, determines the focal position for the lenses 310A, 310B, and outputs this to the image capture sections 321A, 321B. The AE processing section 322b determines the aperture number and shutter speed based on a pre-image, and outputs these to the image capture sections 321A, 321B.

Note that as a detection method for focal position using the AF processing section 322a, there is no limit to an active method using the distance data, and a passive method may be used that detects the focal position by utilizing image contrast.

In a state in which the release button 302 is not operated, in order to ascertain the image capture environment, the image capture controller 322 controls the image capture sections 321A, 321B so as to sequentially generate through images with fewer pixels that the main images of the left eye image G1 and the right eye image G2 at specific intervals (for example at intervals of 1/30 of a second). Then when the release button 302 has been fully depressed, in order to start the main image capture, the image capture controller 322 controls the image capture sections 321A, 321B so as to start to generate the main images of the left eye image G1 and the right eye image G2.

The above explanation refers to a still imaging mode, and in the fifth exemplary embodiment it is also possible to set a video imaging mode. In the video imaging mode, video imaging is started when the release button 302 has been pressed, the left eye image G1 and the right eye image G2 are generated for each frame, and the video imaging is stopped when the release button 302 is pressed again.

The image processing section 323 performs image processing such as white balance adjustment, shading correction, sharpness correction and color correction on digital image data of the left eye image G1 and the right eye image G2 acquired by the image capture sections 321A, 321B.

The compression/decompression processor 324 performs compression processing with a compression format such as for example JPEG on image data expressing the left eye image G1 and the right eye image G2 that has been processed by the image processing section 323, and generates the 3D viewing image file F0. The 3D viewing image file F0 includes image data for the left eye image G1 and the right eye image G2, and includes associated data such as the base line length, angle of convergence, and date and time of image capture, as well as viewpoint data expressing a viewpoint position, based on for example an Exif format.

The frame memory 325 is a working memory used when performing various types of processing, including the previously mentioned processing performed by the image processing section 323, on the image data expressing the left eye image G1 and the right eye image G2 acquired by the image capture sections 321A, 321B.

The media controller 326 accesses the recording medium 329 and controls writing and reading of for example image files.

The internal memory 327 is stored with various constants set in the multi-lens camera 301 and a program executed by the CPU 335.

In 3D viewing, the display controller 328 displays on the monitor 307 a 3D viewing image GR stored in the frame memory 325 or stored in the recording medium 329.

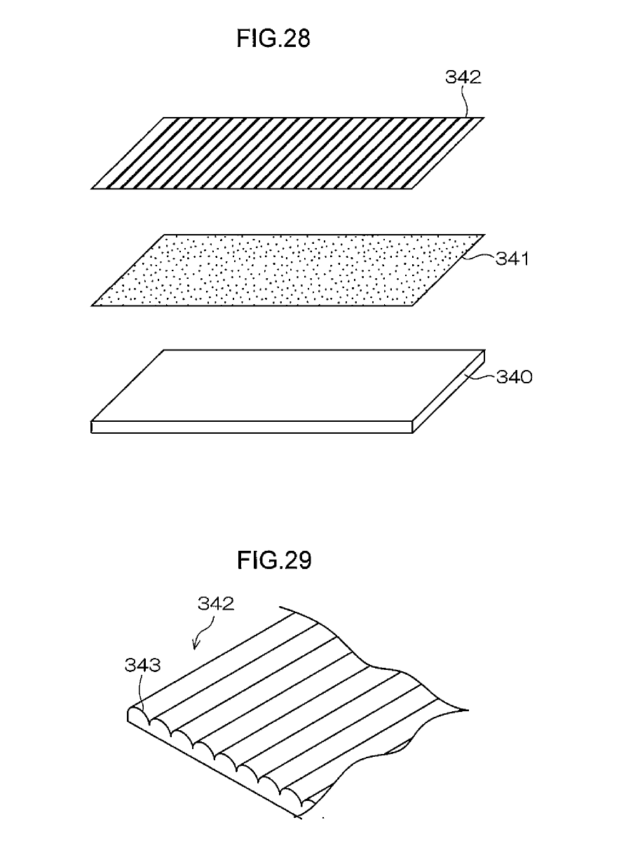

FIG. 28 is an exploded perspective view illustrating a configuration of the monitor 307. As shown in FIG. 28, the monitor 307 is configured with stacked layers of a back light unit 340 that emits LED light and a liquid crystal panel 341 for performing various displays, with a lenticular sheet 342 attached to the front face of the liquid crystal panel 341.

FIG. 29 is a diagram illustrating a configuration of a lenticular sheet. As shown in FIG. 29, the lenticular sheet 342 is configured with plural cylindrical lenses 343 disposed side-by-side in a row along the direction of the base line.

The multi-lens camera 301 is further equipped with a 3D processor 330. The 3D processor 330 performs 3D processing on the left eye image G1 and the right eye image G2 to generate a 3D viewing image GR in order to perform 3D display of the left eye image G1 and the right eye image G2 on the monitor 307.

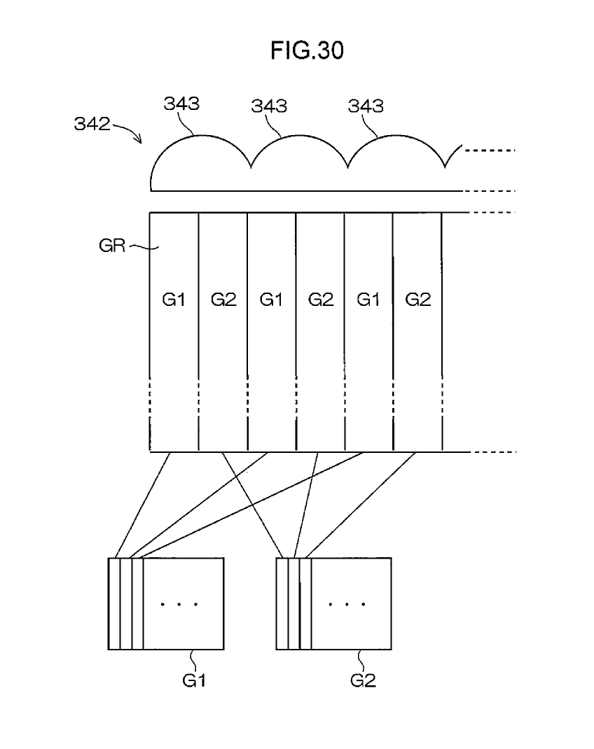

FIG. 30 is a diagram to explain 3D processing on a left eye image G1 and a right eye image G2. As shown in FIG. 30, the 3D processor 330 performs 3D processing by respectively cutting the left eye image G1 and the right eye image G2 into strip shapes along a direction perpendicular to the base line, and alternately disposing the cut strip shapes of the left eye image G1 and the right eye image G2 at corresponding positions on each of the cylindrical lenses 343 of the lenticular sheet 342, thereby generating the 3D viewing image GR. Image pairs of the left eye image G1 and the right eye image G2 configuring the 3D viewing image GR are accordingly respectively disposed so as to correspond to each individual cylindrical lens.

The 3D processor 330 is capable of adjusting parallax of the left eye image G1 and the right eye image G2. Parallax here refers to the amount of displacement in pixel positions in the lateral direction, namely in the direction along the base line, between the left eye image G1 and the right eye image G2 for subjects included in both the left eye image G1 and the right eye image G2. It is possible to make the 3D sensation of subjects included in the 3D viewing image GR appropriate by adjusting the parallax.

The 3D processor 330 may adjust the parallax of the left eye image G1 and the right eye image G2 obtained by the image capture sections 321A, 321B in real time, and may adjust the parallax of the left eye image G1 and the right eye image G2 prerecorded on the recording medium 329.

The 3D video editing routines explained with respect to the first to the fourth exemplary embodiment are executed in the multi-lens camera 301 configured as described above. Note that the programs for first and second parallax adjustment routines are pre-stored in the internal memory 327.

Note that the present invention is not limited to the above exemplary embodiments, and it is possible to apply various changes to the design within a range of matter recited in the scope of the patent claims.

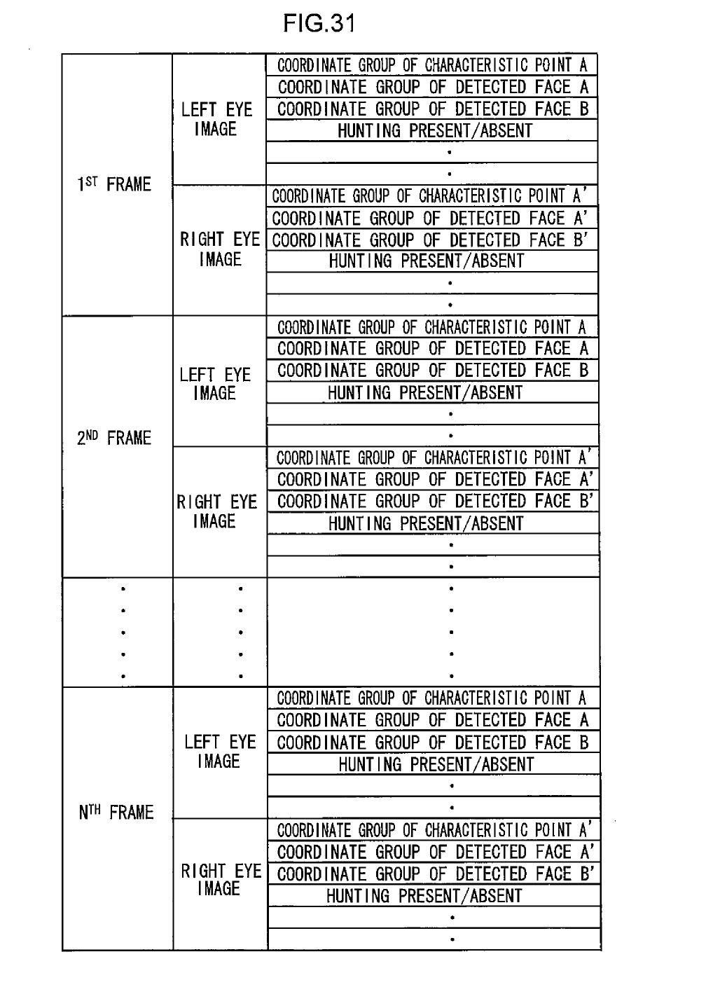

For example, in the first to the fourth exemplary embodiments described above, in place of direct acquisition of parallax, parallax related data may be acquired as illustrated in the example of FIG. 31.

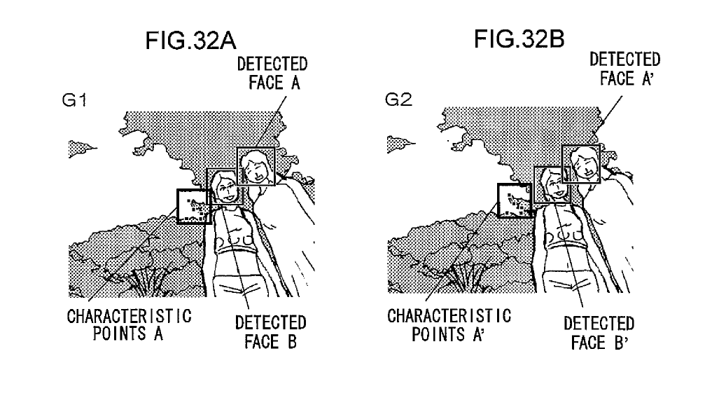

FIG. 32A and FIG. 32B are explanatory diagrams of parallax related data. Regarding parallax related data for the left eye image (the left eye image G1) and the right eye image (the right eye image G2) for each of the frames, this corresponds to a coordinate group of characteristic points A, a coordinate group of a characteristic face A, a coordinate group of a characteristic face B, and whether or not there is hunting present. Parallax adjustment may then be performed using this parallax related data.

Explanation has been given in the fifth exemplary embodiment of an example of a case in which a 3D viewing image is displayed on the monitor 307, however there is no limitation thereto. For example, configuration may be made such that the display device 12 illustrated in FIG. 1 and the multi-lens camera 301 are connected to enable wired or wireless communication, the left eye image G1 and the right eye image G2 generated by the multi-lens camera 301 transmitted to the display device 12, and a 3D viewing image based on the left eye image G1 and the right eye image G2 transmitted from the multi-lens camera 301 and displayed using the display device 12. In such cases, a user is, for example, able to perform editing and parallax amount adjustment of the image data by operating the operation buttons 308 of the multi-lens camera 301 whilst viewing the 3D viewing image displayed on the display device 12. Moreover, it is also possible in cases in which the display device 12 and the multi-lens camera 301 are connected together, to perform editing or parallax amount adjustment of image data stored on the storage medium 34 of the display device 12. In such cases, editing and parallax amount adjustment of the image data may be performed using the remote controller 50 illustrated in FIG. 13 or using the operation section 13 of the display device 12.

Note that although explanation has been given of cases in which a user views a 3D viewing image using the liquid crystal shutter glasses 14 in the first to the fourth exemplary embodiments, and a user views the 3D viewing image using the lenticular sheet 342 in the fifth exemplary embodiment, there is no limitation thereto. For example, the lenticular sheet 42 may be applied to the monitor 12A of the display device 12 explained in the first to the fourth exemplary embodiment, and a 3D viewing image may be viewed by a user without using the liquid crystal shutter glasses 14 by generating the 3D viewing image GR as explained in the fifth exemplary embodiment and displaying it on the monitor 12A. Moreover, instead of providing the lenticular sheet 342 on the monitor 307 of the multi-lens camera 301 as explained in the fifth exemplary embodiment, the left eye image G1 and the right eye image G2 may be alternately displayed on the monitor 307, and a 3D viewing image viewed by a user using the liquid crystal shutter glasses 14 as explained in the first to the fourth exemplary embodiments.

Explanation has been given in each of the above exemplary embodiments of examples in which a parallax amount is acquired based on a face region of the same person, however there is no limitation thereto. For example, application may be made with a face region of a pet such as a dog or cat, an outline of a characteristic portion of a specific animal or plant, or an outline of a characteristic portion of something other than a living thing (for example an automobile, a train or a building), used as the parallax amount acquisition subject. An example of such a case is an embodiment in which an image dictionary stored with characteristic amount data representing characteristics of acquisition target images for use in pattern matching is prepared in advance, the acquisition target is specified by using this image dictionary, and the parallax amount of the specified acquisition target is computed. Note that the image dictionary is preferably one that is capable of customizing by users. An example of such cases is an image dictionary in which it is possible to additionally record characteristic amount data representing the characteristics of an image that is a representation of an object specified as the parallax amount acquisition subject by the user in the image dictionary, and possible to erase from the image dictionary.

Moreover, the parallax amount acquisition subject may be an imaging subject in a frame that has a spatially frequency of a specific value or greater. In such cases, for example, the imaging subject may be based on a region enclosed by a closed curve defined in each frame by the specific value spatially frequency (edge component), or the imaging subject may be based on a closed curve region defined in each frame by spatially frequency of spatially frequencies (specific values) that exceed the specific spatially frequency. Note that the imaging subject may be a closed curve region itself that is defined in each frame by a spatially frequency of the specific spatially frequency or greater, may be a region of a geometric shape such as a smallest rectangle or smallest circle within which the closed curve region defined by the spatially frequency of the specific value is inscribed, or may be a region obtained by deforming a closed curve region according to a specific algorithm. The parallax amount acquisition subject may any imaging subject predetermined in each of the frames.

Explanation has been given in each of the above exemplary embodiments of cases in which for each object the parallax amount is acquired in the frames for an object that is at the indention side and an object that is at the projection side for an object with a comparatively large parallax amount adjustment amount at the far side and the near side, and change with time of the acquired parallax amount expressed as a graph for each of the objects, however there is no limitation thereto. Configuration may be made such that the parallax amount is acquired for any single object in the frames and the change with time in this parallax amount expressed as a graph, or the parallax amount of 3 or more objects in the frames and the change with time in these individual parallax amounts expressed as a graph.

Moreover, although in each of the above exemplary embodiments the change with time of the parallax amounts are represented as graphs, there is no limitation thereto and representation may be made after converting into a numerical value. In such cases a numerical value representing a predetermined parallax amount may be comparably displayed as an abnormal parallax amount. Moreover, together with display of the parallax amounts as graphs, display may also be made of numerical values representing parallax amounts. In such cases, the numerical values representing the parallax amount are preferably those relating to the frame being displayed at the current point in time. This thereby makes it possible to even more easily ascertain whether or not the parallax amounts are abnormal for the objects contained in the frame being displayed at the current point in time.

Moreover, although explanation has been given in each of the above exemplary embodiments of examples of embodiments in which overlaid display is made of the parallax amount display screen 40 on the frame being displayed on the monitor 12A, there is no limitation thereto, and the frame being reproduced and the parallax amount display screen 40 may be displayed on separate monitors. In such cases, preferably a marker is displayed in the parallax amount display screen 40 at a specific position of the parallax amount based on the object in the frame being displayed at the current point in time.

Moreover, although explanation has been given in each of the above exemplary embodiments of examples of embodiments in which there is a direct comparison between a graph representing the parallax amount and an index (permissible limit line) for determining whether or not the parallax amount is abnormal, configuration may be made such that an indirect comparison is made by alternately displaying a graph representing the parallax amount and an index for determining whether or not the parallax amount is abnormal. In such cases, what amounts in practice to a direct comparison can be made by alternately display at high speed.

All cited documents, patent applications and technical standards mentioned in the present specification are incorporated by reference in the present specification to the same extent as if the individual cited document, patent application, or technical standard was specifically and individually indicated to be incorporated by reference.

1. An image processing apparatus comprising:
an image acquisition means that acquires successive frame images obtained by successively imaging the same subject from a plurality of respective viewpoints;
a parallax amount acquisition means that acquires parallax amounts for each of a plurality of frame images based on each of the plurality of frame images configuring the successive frame images acquired using the image acquisition means;
a display means that displays frame images configuring successive frame images acquired using the image acquisition means so as to be visualized as a 3D viewing image;
a reception means that receives processing instruction data that instructs parallax amount processing on the frame image;
a processing means that performs the parallax amount processing instructed by the processing instruction data received by the reception means on the frame image displayed on the display means, and performs parallax amount processing on a plurality of frame images before and after the frame image such that the parallax amount processing gradually gets smaller from the instructed parallax amount with distance of the before/after frame image away from the frame image being displayed; and
a control means that during display on the display means of the frame image instructed for parallax amount processing by the processing means controls the display means so as to associate together and display parallax amount related data related to the parallax amount acquired by the parallax amount acquisition means with an index for determining whether or not the parallax amount is abnormal.

2. The image processing apparatus of claim 1, wherein the parallax amount acquisition means acquires a parallax amount based on a predetermined subject image as a subject image of a parallax amount acquisition subject in the frame image.

3. The image processing apparatus of claim 2, wherein a subject image with a spatial frequency of a specific value or greater in the frame image is used as the predetermined subject image.

4. The image processing apparatus of claim 1, wherein the control means during display on the display means of the frame image instructed for parallax amount processing by the processing means further controls the display means so as to display the following associated with each other: data representing a permissible limit of parallax amount; data representing change with time in parallax amount; and data enabling parallax of a frame image currently being displayed to be ascertained in the data representing changes with time in the parallax amount.

5. The image processing apparatus of claim 4 wherein the data representing the parallax amount permissible limit and the data representing the change with time in the parallax amount are each respectively associated with the far side and the near side of the subject image.

6. The image processing apparatus of claim 1, further comprising an abnormal determination means that determines the parallax amount to be abnormal in at least one case out of the group consisting of
a case in which change at fixed durations in the parallax amount acquired by the parallax amount acquisition means is greater than a specific value,
a case in which the parallax amount reaches a predetermined permissible limit value, and
a case in which the parallax amount acquisition subject cannot be detected; wherein,
in cases in which the parallax amount has been determined to be abnormal by the abnormal determination means, the control means further controls the display means such that a warning is displayed at the same time as displaying the frame image corresponding to the parallax amount.

7. The image processing apparatus of claim 6, further comprising a parallax adjustment means that performs a first parallax adjustment in cases in which it is determined by the abnormal determination means that the parallax amount is not abnormal, and that switches control to and performs parallax adjustment by a second parallax adjustment different from control of the first parallax adjustment in cases in which it is determined by the abnormal determination means that the parallax amount is abnormal; wherein,
in cases in which the frame image that is subject to processing by the processing means is displayed on the display means, the control means further controls the display means such that the frame image to which parallax adjustment has been performed by the parallax adjustment means is displayed.

8. The image processing apparatus of claim 7, wherein the parallax adjustment means performs parallax adjustment within a range of a predetermined parallax amount maximum amount in cases in which the parallax amount is determined to be abnormal by the abnormal determination means.

9. The image processing apparatus of claim 7, wherein the parallax adjustment means performs parallax adjustment using the parallax amount of the previous frame in cases in which the parallax amount is determined to be abnormal by the abnormal determination means.

10. The image processing apparatus of claim 7, wherein the parallax adjustment means lowers the frequency of parallax adjustment when the parallax amount is determined to be abnormal by the abnormal determination means.

11. A multi-lens image capture apparatus comprising:
the image processing apparatus of claim 1; and
an image capture means that generates the successive frame images by capturing successive frames of the same subject from a plurality of viewpoints.

12. An image processing method comprising:
acquiring successive frame images obtained by successively imaging the same subject from a plurality of respective viewpoints;
acquiring parallax amounts for each of a plurality of frame images based on each of the plurality of frame images configuring the acquired successive frame images;
displaying frame images configuring the acquired successive frame images so as to be visualized as a 3D viewing image;
receiving processing instruction data that instructs parallax amount processing on the frame image;
performing the parallax amount processing instructed by the received processing instruction data on the displayed frame image, and performing parallax processing on a plurality of frame images before and after the frame image such that the parallax amount processing gradually gets smaller from the instructed parallax amount with distance of the before/after frame image away from the frame image being displayed; and
during display of the frame image instructed for parallax amount processing, associating together and displaying parallax amount related data related to the acquired parallax amount with an index for determining whether or not the parallax amount is abnormal.

13. A program that causes a computer to function as
an image acquisition means that acquires successive frame images obtained by successively imaging the same subject from a plurality of respective viewpoints;
a parallax amount acquisition means that acquires parallax amounts for each of a plurality of frame images based on each of the plurality of frame images configuring the successive frame images acquired using the image acquisition means;
a means that displays on a display means frame images configuring successive frame images acquired using the image acquisition means so as to be visualized as a 3D viewing image;
a reception means that receives processing instruction data that instructs parallax amount processing on the frame image;
a processing means that performs the parallax amount processing instructed by the processing instruction data received by the reception means on the frame image displayed on the display means, and performs parallax amount processing on a plurality of frame images before and after the frame image such that the parallax amount processing gradually gets smaller from the instructed parallax amount with distance of the before/after frame image away from the frame image being displayed; and
a control means that during display on the display means of the frame image instructed for parallax amount processing by the processing means controls the display means so as to associate together and display parallax amount related data related to the parallax amount acquired by the parallax amount acquisition means with an index for determining whether or not the parallax amount is abnormal.

14. The image processing apparatus of claim 2, wherein the control means during display on the display means of the frame image instructed for parallax amount processing by the processing means further controls the display means so as to display the following associated with each other: data representing a permissible limit of parallax amount; data representing change with time in parallax amount; and data enabling parallax of a frame image currently being displayed to be ascertained in the data representing changes with time in the parallax amount.

15. The image processing apparatus of claim 3, wherein the control means during display on the display means of the frame image instructed for parallax amount processing by the processing means further controls the display means so as to display the following associated with each other: data representing a permissible limit of parallax amount; data representing change with time in parallax amount; and data enabling parallax of a frame image currently being displayed to be ascertained in the data representing changes with time in the parallax amount.

16. The image processing apparatus of claim 2, further comprising an abnormal determination means that determines the parallax amount to be abnormal in at least one case out of the group consisting of
a case in which change at fixed durations in the parallax amount acquired by the parallax amount acquisition means is greater than a specific value,
a case in which the parallax amount reaches a predetermined permissible limit value, and
a case in which the parallax amount acquisition subject cannot be detected; wherein,
in cases in which the parallax amount has been determined to be abnormal by the abnormal determination means, the control means further controls the display means such that a warning is displayed at the same time as displaying the frame image corresponding to the parallax amount.

17. The image processing apparatus of claim 3, further comprising an abnormal determination means that determines the parallax amount to be abnormal in at least one case out of the group consisting of
a case in which change at fixed durations in the parallax amount acquired by the parallax amount acquisition means is greater than a specific value,
a case in which the parallax amount reaches a predetermined permissible limit value, and
a case in which the parallax amount acquisition subject cannot be detected; wherein,
in cases in which the parallax amount has been determined to be abnormal by the abnormal determination means, the control means further controls the display means such that a warning is displayed at the same time as displaying the frame image corresponding to the parallax amount.

18. The image processing apparatus of claim 4, further comprising an abnormal determination means that determines the parallax amount to be abnormal in at least one case out of the group consisting of
a case in which change at fixed durations in the parallax amount acquired by the parallax amount acquisition means is greater than a specific value,
a case in which the parallax amount reaches a predetermined permissible limit value, and
a case in which the parallax amount acquisition subject cannot be detected; wherein,
in cases in which the parallax amount has been determined to be abnormal by the abnormal determination means, the control means further controls the display means such that a warning is displayed at the same time as displaying the frame image corresponding to the parallax amount.

19. The image processing apparatus of claim 5, further comprising an abnormal determination means that determines the parallax amount to be abnormal in at least one case out of the group consisting of
a case in which change at fixed durations in the parallax amount acquired by the parallax amount acquisition means is greater than a specific value,
a case in which the parallax amount reaches a predetermined permissible limit value, and
a case in which the parallax amount acquisition subject cannot be detected; wherein,
in cases in which the parallax amount has been determined to be abnormal by the abnormal determination means, the control means further controls the display means such that a warning is displayed at the same time as displaying the frame image corresponding to the parallax amount.

20. The image processing apparatus of claim 8, wherein the parallax adjustment means performs parallax adjustment using the parallax amount of the previous frame in cases in which the parallax amount is determined to be abnormal by the abnormal determination means.
